(19) United States
(12) Patent Application Publication
(10) Pub. No.: US 2026/0302533 A1
(43) Pub. Date: Oct. 1, 2026

(54) SEPARATOR, SECONDARY BATTERY, AND A METHOD FOR MANUFACTURING SEPARATOR

(71) Applicant: Semiconductor Energy Laboratory Co., Ltd., Atsugi-shi (JP)

(72) Inventors: Kaori OGITA, Isehara (JP); Tetsuji ISHITANI, Atsugi (JP); Shuhei YOSHITOMI, Ayase (JP); Fumiko TANAKA, Atsugi (JP); Shotaro MURATSUBAKI, Atsugi (JP); Teppei OGUNI, Atsugi (JP)

(21) Appl. No.: 19/705,898

(22) Filed: Jun. 12, 2026

Related U.S. Application Data
(62) Division of application No. 18/029,779, filed on Oct. 19, 2021.

(30) Foreign Application Priority Data
Oct. 26, 2020 (JP) 2020-179168

(51) Int. Cl. H01M 50/451; H01M 10/0525; H01M 50/403; H01M 50/434; H01M 50/491

(52) U.S. Cl. CPC H01M 50/451; H01M 10/0525; H01M 50/403; H01M 50/434; H01M 50/491

(57) ABSTRACT

A secondary battery with little deterioration is provided. A secondary battery with high safety is provided. A separator having excellent characteristics is provided. A separator achieving the secondary battery with high safety is provided. A novel separator is provided. In the separator, a polymer porous film and a layer including a ceramic-based material containing a metal oxide microparticle are stacked, the thickness of the layer including a ceramic-based material is greater than or equal to 1 μm and less than or equal to 100 μm, and the film thickness of the polymer porous film is greater than or equal to 4 μm and less than or equal to 50 μm.

### TECHNICAL FIELD

One embodiment of the present invention relates to a secondary battery using a separator and a manufacturing method thereof. Another embodiment of the present invention relates to a portable information terminal, a vehicle, and the like each including a secondary battery.

One embodiment of the present invention relates to an object, a method, or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

Note that in this specification, power storage devices mean all elements and devices each having a function of storing power. For example, a power storage device (also referred to as a secondary battery) such as a lithium-ion secondary battery, a lithium-ion capacitor, and an electric double-layer capacitor are included.

### BACKGROUND ART

In recent years, a variety of power storage devices such as lithium-ion secondary batteries, lithium-ion capacitors, and air batteries have been actively developed. In particular, demand for lithium-ion secondary batteries with high output and high energy density has rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential for today's information society as rechargeable energy supply sources.

The improvement of a separator has been studied to improve thermal and electrochemical safety and performance of a lithium-ion secondary battery at the same time.

For example, Patent Document 1 discloses a method for manufacturing an organic-inorganic composite porous separator film containing an organic substance and an inorganic substance.

### REFERENCE

### Patent Document

[Patent Document 1] Japanese Translation of PCT International Application No. 2008-524824

### SUMMARY OF THE INVENTION

### Problems to be Solved by the Invention

An object of one embodiment of the present invention is to provide a secondary battery with little deterioration. Another object of one embodiment of the present invention is to provide a secondary battery with high safety. Another object of one embodiment of the present invention is to provide a separator having excellent characteristics. Another object of one embodiment of the present invention is to provide a separator achieving highly safe secondary battery. Another object of one embodiment of the present invention is to provide a novel separator. Another object of one embodiment of the present invention is to provide a method for manufacturing a separator achieving a highly safe secondary battery. Another object of one embodiment of the present invention is to provide a method for manufacturing a novel separator.

Note that the description of these objects does not preclude the existence of other objects. One embodiment of the present invention does not need to achieve all these objects. Other objects can be derived from the description of the specification, the drawings, and the claims. Means for Solving the Problems

One embodiment of the present invention is a separator in which a polymer porous film and a layer containing a ceramic-based material containing a metal oxide microparticle are stacked, the thickness of the layer containing the ceramic-based material is greater than or equal to 1 μm and less than or equal to 100 μm, and the thickness of the polymer porous film is greater than or equal to 4 μm and less than or equal to 50 μm.

Another embodiment of the present invention is a separator in which the density of a layer comprising a ceramic-based material is greater than or equal to 0.1 g/cm³ and less than or equal to 2 g/cm³.

Another embodiment of the present invention is a separator in which the porosity of a polymer porous film is higher than or equal to 20 volume % and lower than or equal to 90 volume %.

Another embodiment of the present invention is a separator in which the weight of a polymer porous film per unit area is greater than or equal to 4 g/m² and less than or equal to 20 g/m², preferably greater than or equal to 5 g/m² and less than or equal to 12 g/m².

Another embodiment of the present invention is a separator in which a metal oxide microparticle contains one or more of magnesium oxide, aluminum oxide, titanium oxide, silicon oxide, magnesium hydroxide, aluminum hydroxide, and titanium hydroxide.

Another embodiment of the present invention is a separator in which a metal oxide microparticle contains magnesium hydroxide.

Another embodiment of the present invention is a separator in which the average particle diameter of a metal oxide microparticle is greater than or equal to 0.01 μm and less than or equal to 50 μm.

Another embodiment of the present invention is a separator in which a layer containing a ceramic-based material is in contact with one surface of a polymer porous film.

Another embodiment of the present invention is a separator in which a polymer porous film and a layer containing a plurality of ceramic-based materials each containing a metal oxide microparticle are stacked, the layer containing the plurality of ceramic-based materials is positioned so that the polymer porous film is sandwiched therebetween, the thickness of the layer containing the ceramic-based materials is greater than or equal to 1 μm and less than or equal to 100 μm, and the thickness of the polymer porous film is greater than or equal to 4 μm and less than or equal to 50 μm.

Another embodiment of the present invention is a separator in which the density of a layer containing ceramic-based materials is greater than or equal to 0.1 g/cm³ and less than or equal to 2 g/cm³.

Another embodiment of the present invention is a separator in which the porosity of a polymer porous film is higher than or equal to 20 volume % and lower than or equal to 90 volume %.

Another embodiment of the present invention is a separator in which the weight of a polymer porous film per unit area is greater than or equal to 4 g/m² and less than or equal to 20 g/m², preferably greater than or equal to 5 g/m² and less than or equal to 12 g/m².

Another embodiment of the present invention is a separator in which a metal oxide microparticle contains one or more of magnesium oxide, aluminum oxide, titanium oxide, silicon oxide, magnesium hydroxide, aluminum hydroxide, and titanium hydroxide.

Another embodiment of the present invention is a separator in which a metal oxide microparticle contains magnesium hydroxide.

Another embodiment of the present invention is a separator in which the average particle diameter of a metal oxide microparticle is greater than or equal to 0.01 μm and less than or equal to 50 μm.

Another embodiment of the present invention is a separator in which a layer containing a ceramic-based material is in contact with one surface of a polymer porous film.

Another embodiment of the present invention is a secondary battery in which a positive electrode, a negative electrode, the separator described above sandwiched between the positive electrode and the negative electrode, and an electrolyte.

With the above structure, the electrolyte is preferably positioned in a hole in a polymer porous film.

Another embodiment of the present invention is a method for manufacturing a separator, including a first step of mixing a ceramic-based material containing a metal oxide microparticle and a first solvent to form a first mixture; a second step of mixing the first mixture, a first binder, and a second solvent to form a second mixture; a third step of mixing the second mixture, a second binder, and a third solvent to form a third mixture; a fourth step of applying the third mixture onto a polymer porous film; and a fifth step of heating the polymer porous film coated with the third mixture at higher than or equal to 60° C. and lower than or equal to 300° C. to be dried.

In the above fifth step, the polymer porous film coated with the third mixture is further preferably heated at higher than or equal to 60° C. and lower than or equal to 200° C. to be dried.

Note that the porosity of the polymer porous film refers to the proportion of the volume of holes occupying the polymer porous film. The porosity of the layer containing the ceramic-based material refers to the proportion of the volume of holes occupying the layer containing the ceramic-based material. The density can be obtained from the thickness, the weight, and the area.

The porosity of the layer containing the ceramic-based material is higher than or equal to 50 volume %, for example.

### Effect of the Invention

One embodiment of the present invention can provide a secondary battery with little deterioration. Another embodiment of the present invention can provide a secondary battery with high safety. Another embodiment of the present invention can provide a separator having excellent characteristics. Another embodiment of the present invention can provide a separator achieving a highly safe secondary battery. Another embodiment of the present invention can provide a novel separator. Another embodiment of the present invention can provide a method for manufacturing a separator achieving a highly safe secondary battery. Another embodiment of the present invention can provide a method for manufacturing a novel separator.

Note that the description of these effects does not preclude the existence of other effects. One embodiment of the present invention does not need to have all these effects. Other effects will be apparent from and can be derived from the description of the specification, the drawings, the claims, and the like.

### BRIEF DESCRIPTION OF THE DRAWINGS

FIG. 1A to FIG. 1D are examples of a cross-sectional view of a secondary battery.

FIG. 2A to FIG. 2D are examples of a cross-sectional view of a secondary battery.

FIG. 3 is a flow chart showing an example of a method for manufacturing a separator coated with a ceramic-based material.

FIG. 4 is a diagram showing a method for forming a material.

FIG. 5 is an example of a process cross-sectional view illustrating one embodiment of the present invention.

FIG. 6 is a diagram illustrating crystal structures of a positive electrode active material.

FIG. 7 is a diagram illustrating crystal structures of a positive electrode active material.

FIG. 8A and FIG. 8B are diagrams illustrating examples of an external appearance of a secondary battery.

FIG. 9A and FIG. 9B are diagrams illustrating a method for manufacturing a secondary battery.

FIG. 10A and FIG. 10B are diagrams illustrating a method for manufacturing a secondary battery.

FIG. 11 is a diagram illustrating an example of an external appearance of a secondary battery.

FIG. 12 is a top view illustrating an example of a manufacturing apparatus for a secondary battery.

FIG. 13 is a cross-sectional view illustrating an example of a method for manufacturing a secondary battery.

FIG. 14A to FIG. 14C are perspective views illustrating an example of a method for manufacturing a secondary battery. FIG. 14D is a cross-sectional view corresponding to FIG. 14C.

FIG. 15A to FIG. 15F are perspective views illustrating an example of a method for manufacturing a secondary battery.

FIG. 16 is a cross-sectional view illustrating an example of a secondary battery.

FIG. 17A is a diagram illustrating an example of a secondary battery. FIG. 17B and FIG. 17C are diagrams illustrating an example of a method for manufacturing a stack.

FIG. 18A to FIG. 18C are diagrams illustrating an example of a method for manufacturing a secondary battery.

FIG. 19A and FIG. 19B are cross-sectional views illustrating examples of a stack. FIG. 19C is a cross-sectional view illustrating an example of a secondary battery.

FIG. 20A and FIG. 20B are diagrams illustrating an example of a secondary battery. FIG. 20C is a diagram illustrating the internal state of a secondary battery.

FIG. 21A to FIG. 21C are diagrams illustrating examples of a secondary battery.

FIG. 22A is a perspective view illustrating an example of a battery pack. FIG. 22B is a block diagram illustrating an example of a battery pack. FIG. 22C is a block diagram illustrating an example of a vehicle including a motor.

FIG. 23A to FIG. 23E are diagrams illustrating examples of transport vehicles.

FIG. 24A is a diagram illustrating an electric bicycle, FIG. 24B is a diagram illustrating a secondary battery of the electric bicycle, and FIG. 24C is a diagram illustrating an electric motorcycle.

FIG. 25A and FIG. 25B are diagrams illustrating examples of a power storage device.

FIG. 26A to FIG. 26E are diagrams illustrating examples of electronic devices.

FIG. 27A to FIG. 27H are diagrams illustrating examples of electronic devices.

FIG. 28A to FIG. 28C are diagrams illustrating examples of an electronic device.

FIG. 29 is a diagram illustrating examples of electronic devices.

FIG. 30A to FIG. 30C are diagrams illustrating examples of electronic devices.

FIG. 31A to FIG. 31C are diagrams illustrating examples of electronic devices.

FIG. 32 is a graph showing measurement results of the concentration of the cobalt solution by an atomic absorption spectrometry method.

### MODE FOR CARRYING OUT THE INVENTION

Embodiments of the present invention are described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

In this specification and the like, crystal planes and orientations are indicated by the Miller index. In the crystallography, a bar is placed over a number in the expression of crystal planes and orientations; however, in this specification and the like, because of application format limitations, crystal planes and orientations are sometimes expressed by placing a minus sign (−) before the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”.

In this specification and the like, a surface portion of a particle of an active material or the like is preferably a region that is less than or equal to 50 nm, further preferably less than or equal to 35 nm, still further preferably less than or equal to 20 nm from the surface, for example. A plane generated by a split or a crack may also be referred to as a surface. In addition, a region which is deeper than the surface portion is referred to as an inner portion.

In this specification and the like, the layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

In this specification and the like, an O3′ type crystal structure of a composite oxide containing lithium and a transition metal belongs to a space group R-3m, and is not a spinel crystal structure but a crystal structure in which an ion of cobalt, magnesium, or the like occupies a site coordinated to six oxygen atoms and the cation arrangement has symmetry similar to that of the spinel crystal structure. Note that in the O3′ type crystal structure, a light element such as lithium sometimes occupies a site coordinated to four oxygen atoms; also in this case, the ion arrangement has symmetry similar to that of the spinel crystal structure.

The O3′ type crystal structure can also be regarded as a crystal structure that includes Li between layers at random but is similar to a CdCl₂ type crystal structure. The crystal structure similar to the CdCl₂ type crystal structure is close to a crystal structure of lithium nickel oxide when charged up to a charge depth of Li_{0.06}NiO₂; however, simple and pure lithium cobalt oxide or a layered rock-salt positive electrode active material containing a large amount of cobalt is known not to have this crystal structure in general.

Anions of a layered rock-salt crystal and anions of a rock-salt crystal have cubic closest packed structures (face-centered cubic lattice structures). Anions of an O3′ type crystal are presumed to form a cubic close-packed structure. When these are in contact with each other, there is a crystal plane at which orientations of cubic closest packed structures composed of anions are aligned. Note that a space group of the layered rock-salt crystal and the O3′ type crystal is R-3m, which is different from a space group Fm-3m of a rock-salt crystal (a space group of a general rock-salt crystal) and a space group Fd-3m of a rock-salt crystal (a space group of a rock-salt crystal having the simplest symmetry); thus, the Miller index of the crystal plane satisfying the above conditions in the layered rock-salt crystal and the O3′ type crystal is different from that in the rock-salt crystal. In this specification, a state where the orientations of the cubic closest packed structures composed of anions in the layered rock-salt crystal, the O3′ type crystal, and the rock-salt crystal are aligned is referred to as a state where crystal orientations are substantially aligned in some cases.

Substantial alignment of the crystal orientations in two regions can be judged from a TEM (transmission electron microscope) image, a STEM (scanning transmission electron microscope) image, an HAADF-STEM (high-angle annular dark-field scanning transmission electron microscope) image, an ABF-STEM (annular bright-field scanning transmission electron microscope) image, or the like. X-ray diffraction (XRD), electron diffraction, neutron diffraction, and the like can also be used for judging. In the STEM image and the like, alignment of cations and anions can be observed as repetition of bright lines and dark lines. When the orientations of cubic closest packed structures in the layered rock-salt crystal and the rock-salt crystal are aligned, a state where the angle made by the repetition of bright lines and dark lines in the layered rock-salt crystal and the rock-salt crystal is less than or equal to +5°, further preferably less than or equal to +2.5° can be observed. Note that in the TEM image and the like, a light element such as oxygen or fluorine cannot be clearly observed in some cases; however, in such a case, alignment of orientations can be judged by arrangement of metal elements.

In this specification and the like, the theoretical capacity of a positive electrode active material refers to the amount of electricity for the case where all the lithium that can be inserted and extracted in the positive electrode active material is extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

The remaining amount of lithium that can be inserted into and extracted from a positive electrode active material is represented by x in a compositional formula, e.g., x in LiₓCoO₂ or x in LiₓMO₂ (Mis a transition metal). x can also be referred to as the occupancy rate of Li in lithium sites. In the case where lithium cobalt oxide satisfies the stoichiometric composition ratio, lithium cobalt oxide is LiCoO₂ and the occupancy rate of Li in the lithium sites is x=1. For a secondary battery after its discharging ends, it can be said that lithium cobalt oxide is LiCoO₂ and x≈1. Here, “discharging ends” means that a voltage becomes lower than or equal to 2.5 V (vs. Li counter electrode) at a current of 100 mA/g, for example. In a lithium-ion secondary battery, the voltage of the lithium-ion secondary battery rapidly decreases when the occupancy rate of lithium in the lithium sites becomes x=1 and more lithium cannot enter the lithium-ion secondary battery. At this time, it can be said that the discharging is terminated. In general, in a lithium-ion secondary battery using LiCoO₂, the discharging voltage rapidly decreases until discharging voltage reaches 2.5 V; thus, discharging is terminated under the above-described conditions.

In this specification and the like, an unbalanced phase change refers to a phenomenon that causes a nonlinear change in physical quantity. For example, an unbalanced phase change might occur before and after peaks in a dQ/dV curve obtained by differentiating capacitance (Q) with voltage (V) (dQ/dV), which can largely change the crystal structure.

A secondary battery includes a positive electrode and a negative electrode, for example. A positive electrode active material is a material included in the positive electrode. The positive electrode active material is a material that performs a reaction contributing to the charging and discharging capacity, for example. Note that the positive electrode active material may partly include a material that does not contribute to the charging and discharging capacity.

In this specification and the like, the positive electrode active material of one embodiment of the present invention is expressed as a positive electrode material, a secondary battery positive electrode material, or the like in some cases. In this specification and the like, the positive electrode active material of one embodiment of the present invention preferably includes a compound. In this specification and the like, the positive electrode active material of one embodiment of the present invention preferably includes a composition. In this specification and the like, the positive electrode active material of one embodiment of the present invention preferably includes a composite.

The discharging rate refers to the relative ratio of a current at the time of discharging to battery capacity and is expressed in a unit C. A current corresponding to 1 C in a battery with a rated capacity X (Ah) is X (A). The case where discharging is performed with a current of 2X (A) is rephrased as to perform discharging at 2 C, and the case where discharging is performed with a current of X/5 (A) is rephrased as to perform discharging at 0.2 C. The same applies to the charging rate; the case where charging is performed with a current of 2X (A) is rephrased as to perform charging at 2 C, and the case where charging is performed with a current of X/5 (A) is rephrased as to perform charging at 0.2 C.

Constant current charging refers to a method of performing charging at a fixed charging rate, for example. Constant voltage charging refers to a charging method in which voltage is fixed when reaching the upper voltage limit, for example. Constant current discharging refers to a method of performing discharging at a fixed discharging rate, for example.

### Embodiment 1

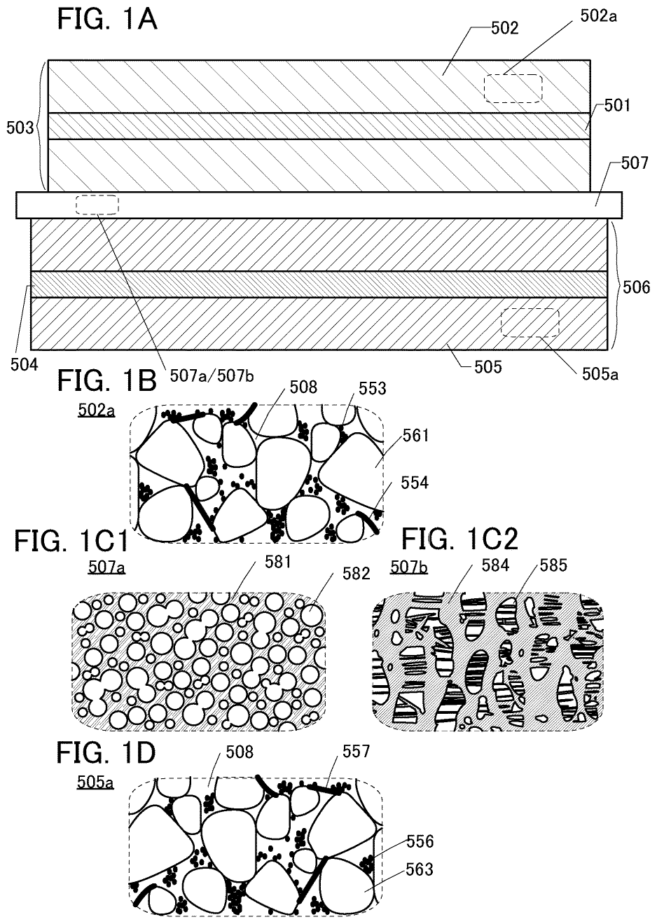

In this embodiment, examples of a secondary battery of one embodiment of the present invention are described with reference to FIG. 1. The secondary battery includes an exterior body (not illustrated), a positive electrode 503, a negative electrode 506, a separator 507, and an electrolyte 508 in which a lithium salt and the like are dissolved. The separator 507 is provided between the positive electrode 503 and the negative electrode 506.

As illustrated in FIG. 1A, the positive electrode 503 includes a positive electrode active material layer 502 and a positive electrode current collector 501, and the positive electrode active material layer 502 includes a positive electrode active material 561, a conductive additive, and a binder. FIG. 1B is an enlarged view of a region 502a of the positive electrode active material layer 502, and illustrates an example in which acetylene black 553 and graphene 554 are used as the conductive additive. Note that the details of the positive electrode will be described later.

The negative electrode 506 includes a negative electrode active material layer 505 and a negative electrode current collector 504. The negative electrode active material layer 505 includes a negative electrode active material 563, a conductive additive, and a binder (not illustrated). FIG. 1D is an enlarged view of a region 505a of the negative electrode active material layer 505, and illustrates an example in which acetylene black 556 and graphene 557 are used as the conductive additive. Note that the details of the negative electrode will be described later.

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

As the binder, for example, water-soluble polymers are preferably used. As the water-soluble polymers, a polysaccharide or the like can be used, for example. As the polysaccharide, a cellulose derivative such as carboxymethyl cellulose (CMC), methyl cellulose, ethyl cellulose, hydroxypropyl cellulose, diacetyl cellulose, or regenerated cellulose, starch, or the like can be used. It is further preferable that such water-soluble polymers be used in combination with any of the above-described rubber materials.

Alternatively, as the binder, it is preferable to use a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVdF), polyacrylonitrile (PAN), ethylene-propylene-diene polymer, polyvinyl acetate, or nitrocellulose.

Two or more of the above-described materials may be used in combination as the binder.

For example, a material having a significant viscosity modifying effect and another material may be used in combination. For example, a rubber material or the like has high adhesion and high elasticity but may have difficulty in viscosity modification when mixed in a solvent. In such a case, a material having a significant viscosity modifying effect and a rubber material are preferably mixed, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose and starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of slurry for an electrode. In this specification, cellulose and a cellulose derivative used as a binder of an electrode include salts thereof.

A water-soluble polymer is easily and stably adsorbed onto a surface of an active material or the like because it has a functional group. When the water-soluble polymer adsorbs the surface of an active material or the like, electrostatic repulsion between particles of an active material or the like occurs; thus, the active material or the like can be stably dispersed. Many cellulose derivatives, such as carboxymethyl cellulose, have a functional group such as a hydroxyl group or a carboxyl group. Because of functional groups, polymers sometimes interact with each other and cover an active material surface in a large area, and are expected to inhibit excess decomposition of an electrolyte solution.

In the case where the binder that covers or is in contact with the active material surface forms a film, the film is expected to serve also as a passivation film to inhibit the decomposition of the electrolyte solution. Here, in the case where the passivation film is formed on the surface of an active material, decomposition of the electrolyte solution at the battery reaction potential can be inhibited, for example. It is further desirable that the passivation film can conduct lithium ions while inhibiting electrical conduction.

An active material layer can be formed in such a manner that an active material, a binder, a conductive additive, and a solvent are mixed to form slurry, the slurry is formed over a current collector, and the solvent is volatilized.

A solvent used for formation of the slurry is preferably a polar solvent. For example, water, methanol, ethanol, acetone, tetrahydrofuran (THF), dimethylformamide (DMF), N-methylpyrrolidone (NMP), dimethyl sulfoxide (DMSO), or a mixed solution of two or more of the above can be used.

For each of the positive electrode current collector 501 and the negative electrode current collector 504, it is possible to use a material which has high conductivity and is not alloyed with carrier ions such as lithium, e.g., a metal such as stainless steel, gold, platinum, zinc, iron, copper, aluminum, or titanium, an alloy thereof, or the like. It is also possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a sheet-like shape, a net-like shape, a punching-metal shape, an expanded-metal shape, or the like as appropriate. The current collector preferably has a thickness greater than or equal to 10 μm and less than or equal to 30 μm.

Note that a material that is not alloyed with carrier ions of lithium or the like is preferably used for the negative electrode current collector 504.

As the current collector, a titanium compound may be stacked over the above-described metal element. As a titanium compound, for example, it is possible to use one selected from titanium nitride, titanium oxide, titanium nitride in which part of nitrogen is substituted by oxygen, titanium oxide in which part of oxygen is substituted by nitrogen, and titanium oxynitride (TiOₓN_{y}, where 0<x<2 and 0<y<1), or a mixture or a stack of two or more of them. Titanium nitride is particularly preferable because it has high conductivity and has a high capability of inhibiting oxidation. Provision of a titanium compound over the surface of the current collector inhibits a reaction between a material contained in the active material layer formed over the current collector and the metal, for example. In the case where the active material layer contains a compound containing oxygen, an oxidation reaction between the metal element and oxygen can be inhibited. In the case where aluminum is used for the current collector and the active material layer is formed using graphene oxide described later, for example, an oxidation reaction between oxygen contained in the graphene oxide and aluminum might occur. In such a case, provision of a titanium compound over aluminum can inhibit an oxidation reaction between the current collector and the graphene oxide.

Graphene or a graphene compound can be used as the graphene 554 and the graphene 557.

The graphene compound in this specification and the like refers to multilayer graphene, multi graphene, graphene oxide, multilayer graphene oxide, multi graphene oxide, reduced graphene oxide, reduced multilayer graphene oxide, reduced multi graphene oxide, graphene quantum dots, and the like. A graphene compound contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. A graphene compound may include a functional group. The graphene compound preferably has a bent shape. A graphene compound may be rounded like a carbon nanofiber.

In a positive electrode or a negative electrode of one embodiment of the present invention, graphene or a graphene compound can function as a conductive additive. A plurality of graphene or graphene compounds form a three-dimensional conductive path in a positive electrode or a negative electrode and can increase the conductivity of the positive electrode or the negative electrode. Because the graphene or the graphene compounds can cling to the particles in the positive electrode or the negative electrode, the collapse of the particles in the positive electrode or the negative electrode can be inhibited and the strength of the positive electrode or the negative electrode can be increased. The graphene or the graphene compounds have a thin sheet shape and can form the excellent conductive path even though occupying a small volume in the positive electrode or the negative electrode, whereby the volume of the active material in the positive electrode or the negative electrode can be increased and the capacity of the secondary battery can be increased.

### [Separator]

As the separator 507, for example, paper, nonwoven fabric, a glass fiber, or ceramic, can be used. Alternatively, nylon (polyamide), vinylon (a polyvinyl alcohol-based fiber), polyester, acrylic, polyolefin, polyurethane, polypropylene, polyethylene, or the like can be used. The separator is preferably formed to have an envelope-like shape to wrap one of the positive electrode and the negative electrode.

For the separator 507, a polymer film containing polypropylene, polyethylene, or the like can be used, for example.

The polymer film containing polypropylene, polyethylene, or the like can be formed by a dry method or a wet method. The dry method is a method for generating a gap between crystals, so that a minute hole is formed by extending the polymer film containing polypropylene, polyethylene, or the like while the polymer film being heated. The wet method is a method for forming a hole by mixing a solvent in a resin to form a film in advance and then extracting the solvent.

FIG. 1C1 illustrates an enlarged view of a region 507a as an example of the separator 507 (in the case of manufacturing by a wet method). This example illustrates a structure including a plurality of holes 582 in a polymer film 581. FIG. 1C2 illustrates an enlarged view of a region 507b as another example of the separator 507 (in the case of manufacturing by a dry method). This example illustrates a structure including a plurality of holes 585 in a polymer film 584.

The diameter of the holes in the separator sometimes differ between a surface of the separator on the positive electrode side and a surface thereof on the negative electrode side. In this specification and the like, the surface portion of the separator is preferably a region that is less than or equal to 5 μm, further preferably a region that is less than or equal to 3 μm from the surface, for example.

The separator may have a multilayer structure. For example, a structure in which two kinds of polymer materials are stacked may also be used.

For example, a structure in which the polymer film containing polypropylene, polyethylene, or the like is coated with a ceramic-based material, a fluorine-based material, a polyamide-based material, a mixture thereof, or the like can be used.

As the ceramic-based material, an oxide containing a metal or a hydroxide containing a metal can be used. As the oxide containing a metal or the hydroxide containing a metal, for example, magnesium oxide, titanium oxide, aluminum oxide, silicon oxide, magnesium hydroxide, aluminum hydroxide, titanium hydroxide, or the like can be used. For the titanium oxide, either a material of a rutile structure or a material of an anatase structure can be used; however, the material of an anatase structure is preferred in some cases. A metal oxide that can be used as the ceramic-based material may be a microparticle.

As coating of the ceramic-based material to the polymer film, for example, coating with a particle, coating with a thin film, or the like can be used.

As the fluorine-based material, for example, PVdF, polytetrafluoroethylene, or the like can be used.

As the polyamide-based material, for example, nylon, aramid (meta-based aramid and para-based aramid), or the like can be used.

When the polymer film is coated with the ceramic-based material, the oxidation resistance is improved; hence, deterioration of the separator in charging and discharging at a high voltage can be inhibited and thus the reliability of the secondary battery can be improved. When the polymer film is coated with the fluorine-based material, the separator is easily brought into close contact with an electrode, resulting in high output characteristics. When the polymer film is coated with the polyamide-based material, in particular, aramid, the heat resistance is improved and thus the safety of the secondary battery can be improved.

In order to increase the amount of adsorption of cobalt, a surface area of the ceramic-based material is preferably increased. A material having a layered crystal structure, such as Mg(OH)₂, easily becomes flat and thin particles. By forming a layer containing the ceramic-based material using such particles, the amount of adsorption of cobalt can be increased. The specific surface area of the ceramic-based material is preferably greater than or equal to 10 m²/g, for example. The specific surface area can be measured by a gas adsorption method or the like.

For example, both surfaces of a film containing polypropylene may be coated with a mixed material of a binder such as PVdF and one or more of the ceramic-based materials selected from magnesium hydroxide and titanium oxide. In addition, a surface of the film containing polypropylene that is in contact with a positive electrode may be coated with a mixed material of a binder such as PVdF and one or more of the ceramic-based materials selected from magnesium hydroxide and titanium oxide, and a surface of the film containing polypropylene that is in contact with a negative electrode may be coated with the fluorine-based material.

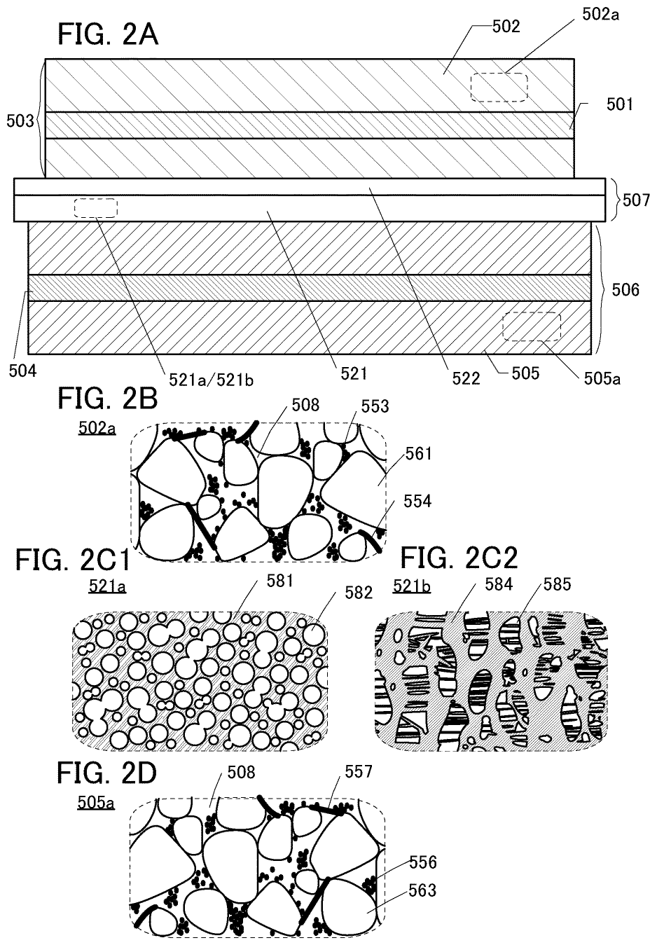

FIG. 2A illustrates the separator 507 including a polymer porous film 521 and a layer 522 containing the ceramic-based material coating the polymer porous film 521. The polymer porous film 521 is formed of the same film as the polymer film 581 having holes illustrated in FIG. 1C1. FIG. 2C1 illustrates an enlarged view of a region 521a as an example of the polymer porous film 521 of the separator 507. In this example, the structure similar to that of the region 507a of the separator 507 in FIG. 1C1 is illustrated. FIG. 2C2 illustrates an enlarged view of a region 521b as another example of the polymer porous film 521 of the separator 507. In this example, the structure similar to that of the region 507b of the separator 507 in FIG. 1C2 is illustrated.

With the use of a separator having a multilayer structure, the capacity per volume of the secondary battery can be increased because the safety of the secondary battery can be maintained even when the total thickness of the separator is small.

In addition, an ionic liquid is incombustible. In the case where the ionic liquid is used for an electrolyte and the ionic liquid is impregnated with the separator, a secondary battery that is less likely to burn can be obtained.

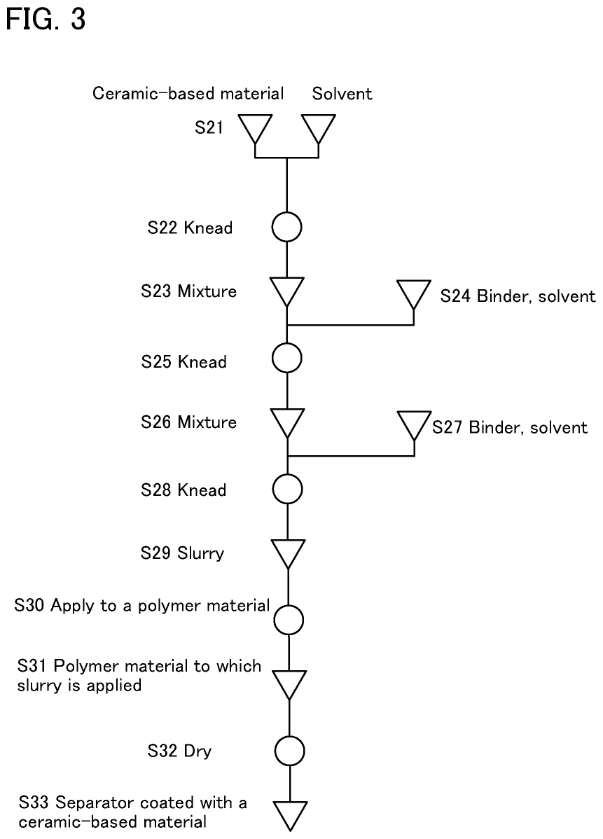

A method for manufacturing a separator coated with the ceramic-based material will be described below with reference to FIG. 3.

First, slurry of the ceramic-based material coating a separator is formed. The slurry can be formed by mixing a ceramic-based material with a solvent and a binder, for example. At this time, mixing may be performed with high viscosity. Kneading and mixing materials in a highly viscous state is sometimes referred to as kneading. As the binder, the binder described in forming the active material layer can be employed.

In Step S21, a ceramic-based material and a solvent are prepared. A combination of a plurality of ceramic-based materials may be used. As the solvent, for example, any one of N-methylpyrrolidone (NMP), water, methanol, ethanol, acetone, tetrahydrofuran (THF), dimethylformamide (DMF), and dimethyl sulfoxide (DMSO), or a mixed solution of two or more of the above can be used.

The mixing may be performed with a mixer. As the mixer, a planetary centrifugal mixer can be used, for example.

In Step S22, by kneading the ceramic-based material and the solvent prepared in Step S21, a mixture can be obtained in Step S23. The ceramic-based material and the solvent are preferably kneaded first to disperse the ceramic-based material.

In Step S24, a binder and a solvent are added to the mixture obtained in Step S23, the resulting mixture is kneaded in Step S25, so that a mixture can be obtained in Step S26. The binder is preferably added little by little in order to prevent cohesion. In Step S25, for example, the mixture obtained in Step S23, the binder, and the solvent are preferably kneaded to form a mixture with a proportion of the solid content of higher than or equal to 50% and lower than or equal to 80%, in which case mixing with high viscosity can be achieved. Note that the proportion of the solid content means the proportion of a solid (here, the ceramic-based material and the binder) in the mixture. Next, in Step S27, a binder and a solvent are added to the mixture obtained in Step S26, the resulting mixture is kneaded in Step S28, so that slurry can be obtained in Step S29. The proportion of the solid content in the formed slurry is preferably 30%.

In Step S30, the formed slurry is applied onto a polymer material. For the application, a blade method, a printing method, or the like may be used. Furthermore, a continuous coater or the like may be used for the application. In Step S31, a polymer material onto which slurry is applied can be obtained.

In Step S32, by a method such as a circulation drying or reduced pressure (vacuum) drying, the solvent is evaporated from the polymer material onto which slurry is applied. The solvent is preferably evaporated using, for example, a warm wind or a hot wind at a temperature higher than or equal to 30° C. and lower than or equal to 160° C. There is no particular limitation on the atmosphere.

Through the above steps, a separator coated with the ceramic-based material can be manufactured in Step S33.

### [Positive Electrode]

Next, a positive electrode is described.

### <Positive Electrode Active Material>

As a positive electrode active material, for example, a composite oxide with an olivine crystal structure, a composite oxide with a layered rock-salt crystal structure, and a composite oxide with a spinel crystal structure are given. For example, a compound such as LiFePO₄, LiFeO₂, LiNiO₂, LiMn₂O₄, V₂O₅, Cr₂O₅, or MnO₂ can be given.

As the positive electrode active material, it is preferable to mix lithium nickel oxide (LiNiO₂ or LiNi₁₋ₓMₓO₂ (0<x<1) (M=Co, Al, or the like) with a lithium-containing material that has a spinel crystal structure and contains manganese, such as LiMn₂O₄. This composition can improve the characteristics of the secondary battery.

As the positive electrode active material, a lithium-manganese composite oxide that can be represented by a composition formula LiₐMn_{b}M_{c}O_{d} can be used. Here, the metal M is preferably silicon, phosphorus, or a metal element other than lithium and manganese, and is further preferably nickel. In the case where the whole particles of a lithium-manganese composite oxide are measured, it is preferable to satisfy 0<a/(b+c)<2; c>0; and 0.26≤(b+c)/d<0.5 at the time of discharging. Note that the proportions of metals, silicon, phosphorus, and the like in the whole particles of a lithium-manganese composite oxide can be measured with, for example, an ICP-MS (inductively coupled plasma mass spectrometer). The proportion of oxygen in the whole particle of a lithium-manganese composite oxide can be measured by, for example, EDX. Alternatively, the proportion of oxygen can be measured by ICPMS analysis combined with fusion gas analysis and valence evaluation of XAFS (X-ray absorption fine structure) analysis. Note that a lithium-manganese composite oxide is an oxide containing at least lithium and manganese, and may contain at least one kind of element selected from a group consisting of chromium, cobalt, aluminum, nickel, iron, magnesium, molybdenum, zinc, indium, gallium, copper, titanium, niobium, silicon, phosphorus, and the like.

In general, the positive electrode active material causes a side reaction of a transition metal such as cobalt is eluted into an electrolyte solution as charging and discharging are repeated. In addition, cobalt ions eluted from the positive electrode active material attach onto a negative electrode surface, so that cobalt is deposited and the thickness of a coating film of the negative electrode surface is increased. However, a separator of one embodiment of the present invention presumably adsorbs cobalt; thus, it is expected that the cobalt concentration eluted into an electrolyte solution can be reduced. Accordingly, the thickness of the coating film of the negative electrode surface can be prevented from becoming thick, and deterioration of the secondary battery can be inhibited.

### <Example of Manufacturing Method of Cobalt-Containing Material>

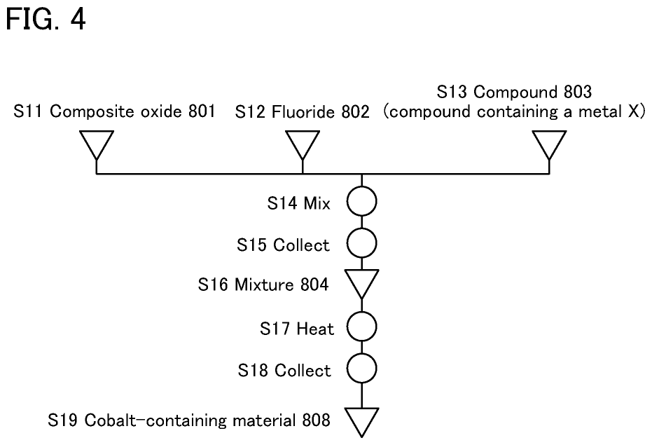

Next, an example of a manufacturing method of LiMO₂ of one embodiment of a material that can be used as the positive electrode active material is described with reference to FIG. 4. As a metal M, for example, at least one of manganese, cobalt, and nickel can be used. The metal M can contain a metal X in addition to any of the metals given above. A substitution position of the metal M is not particularly limited. A cobalt-containing material in which the metal X is Mg is described as an example below. Note that the positive electrode active material of one embodiment of the present invention has a crystal structure of the lithium composite oxide represented by LiMO₂, but the composition is not limited to Li:M:O=1:1:2.

First, in Step S11, a composite oxide containing lithium, a transition metal, and oxygen is used as a composite oxide 801. Here, one or more transition metals including cobalt are preferably used.

The composite oxide containing lithium, a transition metal, and oxygen can be synthesized by heating a lithium source and a transition metal source in an oxygen atmosphere. As the transition metal source, a metal that can form, together with lithium, a layered rock-salt composite oxide belonging to the space group R-3m is preferably used. For example, at least one of manganese, cobalt, and nickel can be used. Aluminum may be used in addition to these transition metals. That is, as the transition metal source, only a cobalt source may be used; only a nickel source may be used; two types of cobalt and manganese sources or two types of cobalt and nickel sources may be used; or three types of cobalt, manganese, and nickel sources may be used. Furthermore, an aluminum source may be used in addition to these metal sources. The heating temperature at this time is preferably higher than the heating temperature in Step S17 described later. For example, the heating can be performed at 1000° C. This heating step is referred to as baking in some cases.

In the case where a composite oxide containing lithium, a transition metal, and oxygen that is synthesized in advance is used, a composite oxide with few impurities is preferably used. In this specification and the like, lithium, cobalt, nickel, manganese, aluminum, and oxygen are the main components of the composite oxide containing lithium, a transition metal, and oxygen, the cobalt-containing material, and the positive electrode active material, and elements other than the main components are regarded as impurities. For example, when analyzed with a glow discharge mass spectroscopy method (GD-MS), the total impurity concentration is preferably less than or equal to 10,000 ppmw (parts per million weight), further preferably less than or equal to 5000 ppmw. In particular, the total impurity concentration of transition metals such as titanium and arsenic is preferably less than or equal to 3000 ppmw, further preferably less than or equal to 1500 ppmw.

For example, as lithium cobalt oxide synthesized in advance, lithium cobalt oxide particles (product name: CELLSEED C-10N) formed by NIPPON CHEMICAL INDUSTRIAL CO., LTD. can be used. This is a lithium cobalt oxide in which the average particle diameter (D50) is approximately 12 μm, and in the impurity analysis by the glow discharge mass spectroscopy method, the magnesium concentration and the fluorine concentration are less than or equal to 50 ppmw, the calcium concentration, the aluminum concentration, and the silicon concentration are less than or equal to 100 ppmw, the nickel concentration is less than or equal to 150 ppmw, the sulfur concentration is less than or equal to 500 ppmw, the arsenic concentration is less than or equal to 1100 ppmw, and the concentrations of elements other than lithium, cobalt, and oxygen are less than or equal to 150 ppmw.

The composite oxide 801 in Step S11 preferably has a layered rock-salt crystal structure with few defects and distortions. Therefore, the composite oxide is preferably a composite oxide with few impurities. In the case where the composite oxide containing lithium, the transition metal, and oxygen includes a large number of impurities, the crystal structure is highly likely to have a large number of defects or distortions.

Furthermore, a fluoride 802 is prepared in Step S12. As the fluoride, for example, lithium fluoride (LiF), magnesium fluoride (MgF₂), aluminum fluoride (AlF₃), titanium fluoride (TiF₄), cobalt fluoride (CoF₂ or CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₂), lanthanum fluoride (LaF₃), sodium aluminum hexafluoride (Na₃AlF₆), or the like can be used. As the fluoride 802, any material that functions as a fluorine source can be used. Thus, in place of the fluoride 802 or as part thereof, fluorine (F₂), carbon fluoride, sulfur fluoride, oxygen fluoride (OF₂, O₂F₂, O₃F₂, O₄F₂, or O₂F), or the like may be used and mixed in an atmosphere in a heating step described later.

In the case where the fluoride 802 is a compound containing the metal X, the fluoride 802 can also serve as a compound 803 (a compound containing the metal X) to be described later.

In this embodiment, lithium fluoride (LiF) is prepared as the fluoride 802. LiF is preferable because it has a cation in common with LiCoO₂. LiF, which has a relatively low melting point of 848° C., is preferable because it is easily melted in an annealing process described later.

In the case where LiF is used as the fluoride 802, the compound 803 (the compound containing the metal X) is preferably prepared in addition to the fluoride 802 in Step S13. The compound 803 is the compound containing the metal X.

In Step S13, the compound 803 is prepared. As the compound 803, a fluoride, an oxide, a hydroxide, or the like of the metal X can be used, and in particular, a fluoride is preferably used.

In the case where magnesium is used as the metal X, MgF₂ or the like can be used as the compound 803. Magnesium can be distributed in the vicinity of the surface of the cobalt-containing material at a high concentration.

In addition to the fluoride 802 and the compound 803, a material containing a metal that is neither cobalt nor the metal X may be mixed. As the material containing a metal that is neither cobalt nor the metal X, a nickel source, a manganese source, an aluminum source, an iron source, a vanadium source, a chromium source, a niobium source, a titanium source, or the like can be mixed, for example. For example, a hydroxide, a fluoride, an oxide, or the like of each metal is preferably pulverized and mixed. The pulverization can be performed by a wet method, for example.

The sequence of Step S11, Step S12, and Step S13 may be freely replaced.

Next, in Step S14, the materials prepared in Step S11, Step S12, and Step S13 are mixed and ground. Although the mixing can be performed by a dry method or a wet method, a wet method is preferable because the materials can be ground to a smaller size. When the mixing is performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent that hardly reacts with lithium is further preferably used. In this embodiment, acetone is used.

For example, a ball mill, a bead mill, or the like can be used for the mixing. When a ball mill is used, zirconia balls are preferably used as media, for example. The mixing and grinding steps are preferably performed sufficiently to pulverize a mixture 804.

Next, in Step S15, the materials mixed and ground in the above manner are collected, the mixture 804 is obtained in Step S16.

For example, the D50 of the mixture 804 is preferably greater than or equal to 600 nm and less than or equal to 20 μm, further preferably greater than or equal to 1 μm and less than or equal to 10 μm.

In Step S17, heat treatment (also referred to as annealing) of the mixture 804 is performed. The heating temperature in Step S17 is further preferably higher than or equal to the temperature at which the mixture 804 melts. The heating temperature is preferably lower than a decomposition temperature of LiCoO₂ (1130° C.).

LiF is used as the fluoride 802 and the annealing in S17 is performed with a lid put on a container, whereby a cobalt-containing material 808 with favorable cycle performance and the like can be manufactured. It is considered that when LiF and MgF₂ are used as the fluoride 802, the reaction with LiCoO₂ is promoted with the annealing temperature in S17 set to higher than or equal to 742° C. to generate LiMO₂ because the eutectic point of LiF and MgF₂ is around 742° C. Furthermore, an endothermic peak of a mixture of LiF, MgF₂, and LiCoO₂ is observed at around 820° C. by differential scanning calorimetry (DSC measurement). Thus, the annealing temperature is preferably higher than or equal to 742° C., further preferably higher than or equal to 820° C.

Accordingly, the annealing temperature is preferably higher than or equal to 742° C. and lower than or equal to 1130° C., further preferably higher than or equal to 742° C. and lower than or equal to 1000° C. Moreover, the annealing temperature is preferably higher than or equal to 820° C. and lower than or equal to 1130° C., further preferably higher than or equal to 820° C. and lower than or equal to 1000° C.

In this embodiment, LiF, which is a fluoride, is considered to function as flux. Accordingly, since the capacity of the heating furnace is larger than the capacity of the container and LiF is lighter than oxygen, it is expected that LiF is volatilized and the reduction of LiF in the mixture 804 inhibits generation of LiMO₂. Thus, heating needs to be performed while volatilization of LiF is inhibited.

Thus, when the mixture 804 is heated in an atmosphere including LiF, that is, the mixture 804 is heated in a state where the partial pressure of LiF in the heating furnace is high, volatilization of LiF in the mixture 804 is inhibited. By performing annealing using the fluoride (LiF or MgF) to form an eutectic mixture with the lid put on a container, the annealing temperature can be lower than the decomposition temperature of LiCoO₂ (1130° C.), specifically, can be decreased to a temperature higher than or equal to 742° C. and lower than or equal to 1000° C., thereby enabling the generation of LiMO₂ to progress efficiently. Accordingly, a cobalt-containing material having favorable characteristics can be manufactured, and the annealing time can be reduced.

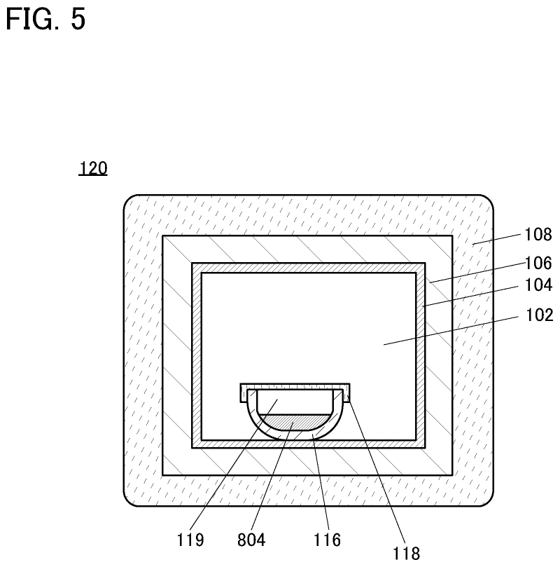

FIG. 5 illustrates an example of the annealing method in S17.

A heating furnace 120 illustrated in FIG. 5 includes a space 102 in the heating furnace, a hot plate 104, a heater unit 106, and a heat insulator 108. It is further preferable to put a lid 118 on a container 116 in annealing. With this structure, a space 119 enclosed by the container 116 and the lid 118 can be filled with an atmosphere including a fluoride. In the annealing, the state of the space 119 is maintained with the lid put on so that the concentration of the gasified fluoride inside the space 119 can be constant or cannot be reduced, in which case fluorine or magnesium can be contained in the vicinity of the particle surface. The atmosphere including a fluoride can be provided in the space 119, which is smaller in capacity than the space 102 in the heating furnace, by volatilization of a smaller amount of a fluoride. This means that an atmosphere including a fluoride can be provided in the reaction system without a significant reduction in the amount of a fluoride included in the mixture 804. Accordingly, LiMO₂ can be produced efficiently. In addition, the use of the lid 118 allows the annealing of the mixture 804 in an atmosphere including a fluoride to be simply and inexpensively performed.

Here, the valence number of Co (cobalt) in LiCoO₂ formed according to one embodiment of the present invention is preferably approximately 3. The valence number of cobalt can be 2 or 3. Thus, to inhibit reduction of cobalt, it is preferable that the atmosphere in the space 102 in the heating furnace contain oxygen, the ratio of oxygen to nitrogen in the atmosphere in the space 102 in the heating furnace be higher than or equal to that in the air atmosphere, and the oxygen concentration in the atmosphere in the space 102 in the heating furnace be higher than or equal to that in the air atmosphere. Thus, an atmosphere including oxygen needs to be introduced into the space in the heating furnace. Note that since bivalent cobalt atoms existing near magnesium atoms are likely to be stable, not all the cobalt atoms may be trivalent.

Thus, in one embodiment of the present invention, before heating is performed, a step of providing an atmosphere including oxygen in the space 102 in the heating furnace and a step of placing the container 116 in which the mixture 804 is placed in the space 102 in the heating furnace are performed. The steps performed in this order enable the mixture 804 to be annealed in an atmosphere including oxygen and a fluoride. During the annealing, the space 102 in the heating furnace is preferably sealed to prevent a gas from being discharged to the outside. For example, it is preferable that no gas flow during the annealing.

Although there is no particular limitation on the method of providing an atmosphere containing oxygen in the space 102 in the heating furnace, examples are a method of introducing an oxygen gas or a gas containing oxygen such as dry air after exhausting air from the space 102 in the heating furnace and a method of flowing an oxygen gas or a gas containing oxygen such as dry air into the space 102 in the heating furnace for a certain period of time. In particular, introducing an oxygen gas after exhausting air from the space 102 in the heating furnace (displacement by oxygen) is preferably performed. Note that the atmosphere of the space 102 in the heating furnace may be regarded as an atmosphere including oxygen.

When the lid 118 is put on the container 116, an atmosphere containing oxygen is provided, and then heating is performed, an appropriate amount of oxygen enters the container 116 through a gap of the lid 118 put on the container 116 and an appropriate amount of fluoride can be kept within the container 116.

Furthermore, the fluoride or the like attached to inner walls of the container 116 and the lid 118 is likely to be fluttered again by the heating and attached to the mixture 804.

The annealing in Step S17 is preferably performed at an appropriate temperature for an appropriate time. The appropriate temperature and time change depending on the conditions such as the particle size and the composition of the particle of the composite oxide 801 in Step S11. In the case where the particle size is small, the annealing is preferably performed at a lower temperature or for a shorter time than annealing in the case where the particle size is large, in some cases. After the annealing in S17, a step of removing the lid is performed.

For example, in the case where the average particle diameter (D50) of particles in Step S11 is approximately 12 μm, the annealing time is preferably 3 hours or longer, further preferably 10 hours or longer.

By contrast, in the case where the average particle diameter (D50) of particles in Step S11 is approximately 5 μm, the annealing time is preferably longer than or equal to 1 hour and shorter than or equal to 10 hours, further preferably approximately 2 hours, for example.

The temperature decreasing time after the annealing is, for example, preferably longer than or equal to 10 hours and shorter than or equal to 50 hours.

Then, the materials annealed in the above manner are collected in Step S18, whereby the cobalt-containing material 808 is obtained in Step S19.

### [Structure of Positive Electrode Active Material]

A material with the layered rock-salt crystal structure, such as lithium cobalt oxide (LiCoO₂), is known to have a high discharging capacity and excel as a positive electrode active material of a secondary battery. As the material with the layered rock-salt crystal structure, for example, a composite oxide represented by LiMO₂ is given. The metal M contains the metal given above. The metal M can contain the metal X given above in addition to the metal M given above.

It is known that the Jahn-Teller effect in a transition metal compound varies in degree according to the number of electrons in the d orbital of the transition metal.

In a compound containing nickel, distortion is likely to be caused because of the Jahn-Teller effect in some cases. Accordingly, when charging and discharging with a high voltage are performed on LiNiO₂, the crystal structure might be broken because of the distortion. The influence of the Jahn-Teller effect is suggested to be small in LiCoO₂; hence, LiCoO₂ is preferable because the resistance to high-voltage charging and discharging is higher in some cases.

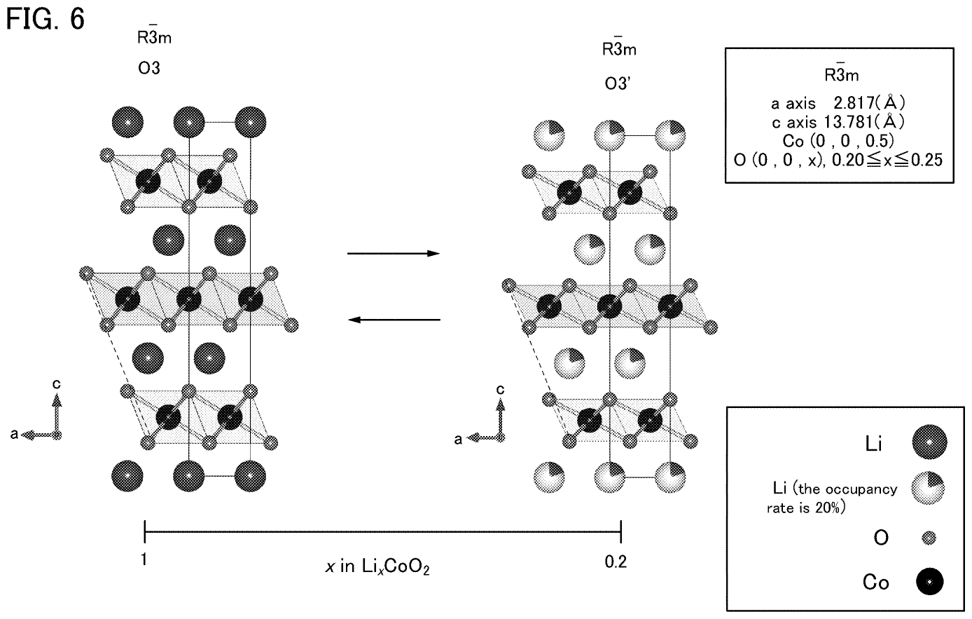

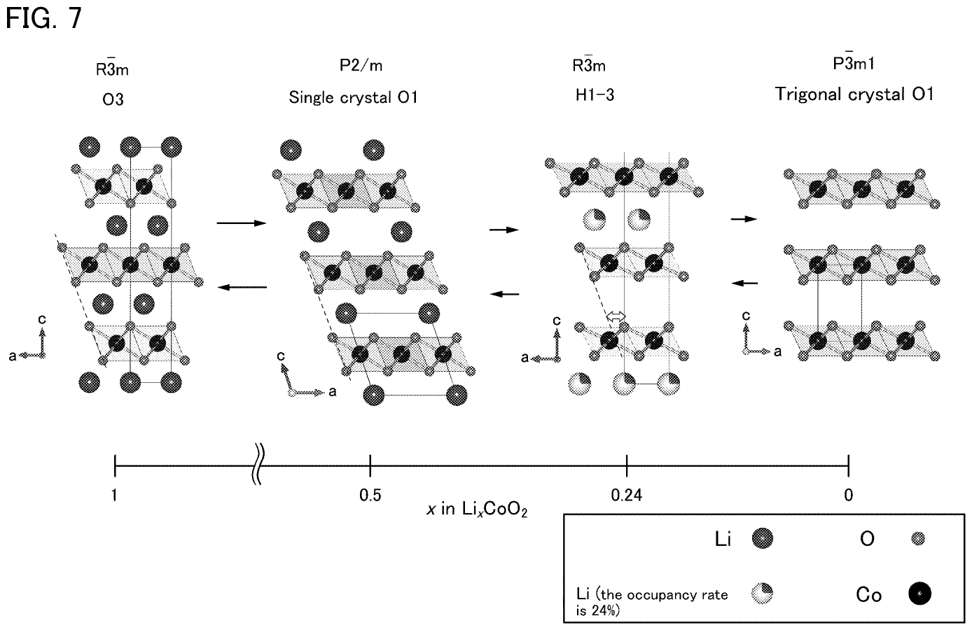

The positive electrode active material is described with reference to FIG. 6 and FIG. 7.

In the positive electrode active material formed according to one embodiment of the present invention, a deviation in the CoO₂ layers can be small in repeated charging and discharging at high voltage. Furthermore, the change in the volume can be small. Thus, the compound can have excellent cycle performance. In addition, the compound can have a stable crystal structure in a high-voltage charged state. Thus, in the compound, sometimes a short circuit is less likely to occur while the high-voltage charged state is maintained. This is preferable because the safety is further improved.

The compound has a small change in the crystal structure and a small difference in volume per the same number of transition metal atoms between a sufficiently discharged state and a high-voltage charged state.

The positive electrode active material of one embodiment of the present invention contains lithium, the above-described metal M, oxygen, and titanium. The positive electrode active material of one embodiment of the present invention preferably contains halogen such as fluorine or chlorine.

For example, the concentrations of elements such as the metal M each have a gradient in each of the regions such as the surface portion, the inner portion, and the first region of the surface portion. That is, for example, the concentration of each element does not change sharply but changes with a gradient in the boundary between the regions. Here, as the metal M, aluminum, nickel, or the like can be used in addition to cobalt and magnesium, for example. In such a case, aluminum and nickel each have, for example, a concentration gradient in each of the regions such as the surface portion, the inner portion, and the first region of the surface portion.

The positive electrode active material of one embodiment of the present invention includes a first region. In the case where the positive electrode active material of one embodiment of the present invention has a form of particles, the first region preferably includes a region located inward from the particle surface. At least part of the surface portion may be included in the first region. The first region is preferably represented by a layered rock-salt crystal structure, and the region is represented by the space group R-3m. The first region is a region containing lithium and the metal M. FIG. 6 illustrates an example of crystal structures of the first region before and after charging and discharging. The surface portion of the positive electrode active material of one embodiment of the present invention may include a crystal that contains magnesium and oxygen and is represented by a structure different from a layered rock-salt crystal structure in addition to or instead of the region represented by a layered rock-salt crystal structure described below with reference to FIG. 6 and the like.

The crystal structure with the occupancy rate, x in LiₓCoO₂ being 1 in FIG. 6 is R-3m (O3), which is the same as that in FIG. 7. In contrast, the first region has a crystal structure different from that of an H1-3 type crystal structure, when x is approximately 0.2. This structure belongs to the space group R-3m and is not the spinel crystal structure but has symmetry in cation arrangement similar to that of the spinel structure because an ion of cobalt, magnesium, or the like occupies a site coordinated to six oxygen atoms. Furthermore, the symmetry of CoO₂ layers of this structure is the same as that in an O3 type crystal structure. This structure is thus referred to as the O3′ type crystal structure in this specification and the like. Note that although lithium exists in any of lithium sites at an approximately 20% probability in the diagram of the O3′ type crystal structure illustrated in FIG. 6, the structure is not limited thereto. Lithium may exist in only some certain lithium sites. In addition, in both the O3 type crystal structure and the O3′ type crystal structure, a slight amount of magnesium preferably exists between the CoO₂ layers, i.e., in lithium sites. In addition, a slight amount of halogen such as fluorine may exist in oxygen sites at random.

Note that in the O3′ type crystal structure, a light element such as lithium sometimes occupies a site coordinated to four oxygen atoms; also in this case, the ion arrangement has symmetry similar to that of the spinel structure.

The O3′ type crystal structure can also be regarded as a crystal structure that includes Li between layers at random but is similar to a CdCl₂ type crystal structure. The crystal structure similar to the CdCl₂ type crystal structure is close to a crystal structure of lithium nickel oxide when charged up to Li_{0.06}NiO₂; however, pure lithium cobalt oxide or a layered rock-salt positive electrode active material containing a large amount of cobalt is known not to have this crystal structure in general.

In the first region, a change in the crystal structure when charging is performed at high voltage and a large amount of lithium is extracted is inhibited as compared with a comparative example described later. As shown by dotted lines in FIG. 6, for example, CoO₂ layers hardly deviate in the crystal structures.

More specifically, the structure of the first region is highly stable even when a charging voltage is high. For example, the H1-3 type crystal structure is formed at a voltage of approximately 4.6 V with the potential of a lithium metal as the reference in FIG. 7; however, the positive electrode active material of one embodiment of the present invention can maintain the crystal structure of R-3m (O3) even at the charging voltage of approximately 4.6 V. Even at higher charging voltages, e.g., a voltage of approximately 4.65 V to 4.7 V with the potential of a lithium metal as the reference, the positive electrode active material of one embodiment of the present invention can have the O3′ type crystal structure. At a charging voltage increased to be higher than 4.7 V, an H1-3 type crystal may be finally observed in the positive electrode active material of one embodiment of the present invention. In addition, the positive electrode active material of one embodiment of the present invention can have the O3′ type crystal structure even at a lower charging voltage (e.g., a charging voltage of greater than or equal to 4.5 V and less than 4.6 V with the potential of a lithium metal as the reference).

Note that in the case where graphite is used as a negative electrode active material in a secondary battery, for example, the voltage of the secondary battery is lower than the above-mentioned voltages by the potential of graphite. The potential of graphite is approximately 0.05 V to 0.2 V with reference to the potential of a lithium metal. Thus, even in a secondary battery that includes graphite as a negative electrode active material and has a voltage of greater than or equal to 4.3 V and less than or equal to 4.5 V, for example, the positive electrode active material of one embodiment of the present invention can maintain the crystal structure of R-3m (O3) and moreover, includes a region that can have the O3′ type crystal structure at higher charging voltages, e.g., a voltage of the secondary battery of greater than 4.5 V and less than or equal to 4.6 V. In addition, the positive electrode active material of one embodiment of the present invention can have the O3′ type crystal structure at lower charging voltages, e.g., at a voltage of the secondary battery of greater than or equal to 4.2 V and less than 4.3 V, in some cases.

Thus, in the first region, the crystal structure is less likely to be broken even when charging and discharging are repeated at high voltage.

In the positive electrode active material of one embodiment of the present invention, the O3 type crystal structure in a discharged state and the O3′ type crystal structure that contain the same number of cobalt atoms have a difference in volume of less than or equal to 2.5%, specifically less than or equal to 2.2%.

Note that in the unit cell of the O3′ type crystal structure, the coordinates of cobalt and oxygen can be represented by Co (0, 0, 0.5) and O (0, 0, x) within the range of 0.20≤x≤0.25.

A slight amount of magnesium existing between the CoO₂ layers, i.e., in lithium sites at random, has an effect of inhibiting a deviation in the CoO₂ layers in high-voltage charging. Thus, when magnesium exists between the CoO₂ layers, the O3′ type crystal structure is likely to be formed.

However, cation mixing occurs when the heat treatment temperature is excessively high; thus, magnesium is highly likely to enter cobalt sites. Magnesium in the cobalt sites is less effective in maintaining the R-3m structure in high-voltage charging in some cases. Furthermore, heat treatment at an excessively high temperature might have an adverse effect; for example, cobalt might be reduced to have a valence of two or lithium might be evaporated.

In view of the above, a halogen compound such as a fluorine compound is preferably added to lithium cobalt oxide before the heat treatment for distributing magnesium throughout the particle. The addition of the halogen compound decreases the melting point of lithium cobalt oxide. The decreased melting point makes it easier to distribute magnesium throughout the particle at a temperature at which the cation mixing is unlikely to occur. Furthermore, the fluorine compound probably increases corrosion resistance to hydrofluoric acid generated by decomposition of an electrolyte solution.

When the magnesium concentration is higher than or equal to a desired value, the effect of stabilizing a crystal structure becomes small in some cases. This is probably because magnesium enters the cobalt sites in addition to the lithium sites. The number of magnesium atoms in the positive electrode active material formed according to one embodiment of the present invention is preferably greater than or equal to 0.001 times and less than or equal to 0.1 times, further preferably greater than 0.01 times and less than 0.04 times, still further preferably approximately 0.02 times the number of cobalt atoms. The magnesium concentration described here may be a value obtained by element analysis on the whole particles of the positive electrode active material using ICP-MS or the like, or may be a value based on the ratio of the raw materials mixed in the process of forming the positive electrode active material, for example.

The number of nickel atoms in the positive electrode active material of one embodiment of the present invention is preferably less than or equal to 7.5%, preferably greater than or equal to 0.05% and less than or equal to 4%, further preferably greater than or equal to 0.1% and less than or equal to 2% of the number of cobalt atoms. The nickel concentration described here may be a value obtained by element analysis on the whole particles of the positive electrode active material using ICP-MS or the like, or may be a value based on the compounding ratio of the raw materials mixed in the process of forming the positive electrode active material, for example.

### <Particle Diameter>

A too large particle diameter of the positive electrode active material of one embodiment of the present invention causes problems such as difficulty in lithium diffusion and too much surface roughness of an active material layer in coating to a current collector. By contrast, when the particle diameter is too small, there are problems such as difficulty in loading of the active material layer in coating to the current collector and overreaction with an electrolyte solution. Therefore, the average particle diameter (D50, also referred to as median diameter) is preferably greater than or equal to 1 μm and less than or equal to 100 μm, further preferably greater than or equal to 2 μm and less than or equal to 40 μm, still further preferably greater than or equal to 5 μm and less than or equal to 30 μm.

### <Analysis Method>

Whether or not a positive electrode active material has the O3′ type crystal structure when charged with high voltage can be determined by analyzing a high-voltage charged positive electrode using XRD, electron diffraction, neutron diffraction, electron spin resonance (ESR), nuclear magnetic resonance (NMR), or the like. XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a secondary battery can be measured with sufficient accuracy, for example.

As described above, the positive electrode active material of one embodiment of the present invention features a small change in the crystal structure between a high-voltage charged state and a discharged state. A material 50 wt % or more of which has the crystal structure that largely changes between the high-voltage charged state and the discharged state is not preferable because the material cannot withstand charging and discharging with high voltage. In addition, it should be noted that an objective crystal structure is not obtained in some cases only by addition of impurity elements. For example, although the positive electrode active material that is lithium cobalt oxide containing magnesium and fluorine is a commonality, the positive electrode active material has the O3′ type crystal structure at 60 wt % or more in some cases, and has the H1-3 type crystal structure at 50 wt % or more in other cases, when charged with a high voltage. Furthermore, at a predetermined voltage, the positive electrode active material has the O3′ type crystal structure at almost 100 wt %, and with an increase in the predetermined voltage, the H1-3 type crystal structure is generated in some cases. Thus, the crystal structure of the positive electrode active material of one embodiment of the present invention is preferably analyzed by XRD or the like. The combination of XRD measurement and another analysis method enables more detailed analysis.

However, the crystal structure of a positive electrode active material in a high voltage charged state or a discharged state may be changed with exposure to the air. For example, the O3′ type crystal structure changes into the H1-3 type crystal structure in some cases. Thus, all samples are preferably handled in an inert atmosphere such as an atmosphere containing argon.

A positive electrode active material illustrated in FIG. 7 is lithium cobalt oxide (LiCoO₂) to which the metal X is not added. The crystal structure of lithium cobalt oxide illustrated in FIG. 7 changes in accordance with a change of the occupancy rate x in LiₓCoO₂.

As illustrated in FIG. 7, in lithium cobalt oxide with the occupancy rate, x in LiₓCoO₂ being 1, there is a region having a crystal structure belonging to the space group R-3m, and a unit cell includes three CoO₂ layers. Thus, this crystal structure is referred to as an O3 type crystal structure in some cases. Note that the CoO₂ layer has a structure in which an octahedral structure with cobalt coordinated to six oxygen atoms continues on a plane in an edge-shared state.

Furthermore, when x in LiₓCoO₂ is 0, lithium cobalt oxide has the trigonal crystal structure of a space group P-3m1, and one CoO₂ layer exists in a unit cell. Hence, this crystal structure is referred to as an O1 type crystal structure in some cases.

When x is approximately 0.24, conventional lithium cobalt oxide has the crystal structure of the space group R-3m. This structure can also be regarded as a structure in which CoO₂ structures such as a structure belonging to P-3m1 (O1) and LiCoO₂ structures such as a structure belonging to R-3m (O3) are alternately stacked. Thus, this crystal structure is referred to as the H1-3 type crystal structure in some cases. Note that since insertion and extraction of lithium do not necessarily uniformly occur in reality, the H1-3 type crystal structure starts to be observed when x is approximately 0.25 experimentally. Moreover, the number of cobalt atoms per unit cell in the actual H1-3 type crystal structure is twice as large as that of cobalt atoms per unit cell in other structures. However, in this specification including FIG. 7, the c-axis of the H1-3 type crystal structure is half that of the unit cell for easy comparison with the other structures.

For the H1-3 type crystal structure, the coordinates of cobalt and oxygen in the unit cell can be expressed as follows, for example: Co (0, 0, 0.42150±0.00016), O₁ (0, 0, 0.27671±0.00045), and O₂ (0, 0, 0.11535±0.00045). O₁ and O₂ are each an oxygen atom. In this manner, the H1-3 type crystal structure is represented by a unit cell containing one cobalt and two oxygen. Meanwhile, the O3′ type crystal structure of one embodiment of the present invention is preferably represented by a unit cell containing one cobalt and one oxygen. This means that the symmetry of cobalt and oxygen differs between the O3′ type crystal structure and the H1-3 type structure, and the amount of change from the O3 type structure is smaller in the O3′ type crystal structure than in the H1-3 type structure. A preferred unit cell for representing a crystal structure in a positive electrode active material is selected such that the value of GOF (goodness of fit) is smaller in Rietveld analysis of XRD, for example.

When charging that makes the occupancy rate x in LiₓCoO₂ be less than or equal to 0.24 and discharging are repeated, the crystal structure of conventional lithium cobalt oxide repeatedly changes between the R-3m (O3) structure in the discharged state and the H1-3 type crystal structure (i.e., an unbalanced phase change).

However, there is a large deviation in the CoO₂ layers between these two crystal structures. As indicated by the dotted lines and the arrow in FIG. 7, the CoO₂ layer in the H1-3 type crystal structure largely deviates from R-3m (O3). Such a dynamic structural change can adversely affect the stability of the crystal structure.

A difference in volume is also large. The O3 type crystal structure in a discharged state and the H1-3 type crystal structure that contain the same number of cobalt atoms have a difference in volume of more than or equal to 3.0%.

In addition, a structure in which CoO₂ layers are arranged continuously, such as P-3m1 (O1), included in the H1-3 type crystal structure is highly likely to be unstable.

Thus, the repeated high-voltage charging and discharging breaks the crystal structure of lithium cobalt oxide. The broken crystal structure triggers deterioration of the cycle performance. This is because the broken crystal structure has a smaller number of sites where lithium can exist stably and makes it difficult to insert and extract lithium.

### [Negative Electrode]

Next, a negative electrode is described.

### <Negative Electrode Active Material>

As a negative electrode active material, for example, an alloy-based material or a carbon-based material can be used.

As the negative electrode active material, an element that enables charging and discharging reactions by an alloying reaction and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon, and especially, silicon has a high theoretical capacity of 4200 mAh/g. For this reason, silicon is preferably used as the negative electrode active material. Alternatively, a compound containing any of the above elements may be used. For example, SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn are given. Here, an element that enables charging and discharging reactions by an alloying reaction and a dealloying reaction with lithium, a compound containing the element, and the like may be referred to as an alloy-based material.

In this specification and the like, SiO refers, for example, to silicon monoxide. Alternatively, SiO can be expressed as SiOₓ. Here, it is preferred that x be 1 or have an approximate value of 1. For example, x is preferably greater than or equal to 0.2 and less than or equal to 1.5, or preferably greater than or equal to 0.3 and less than or equal to 1.2.

As the carbon-based material, graphite, graphitizing carbon (soft carbon), non-graphitizing carbon (hard carbon), carbon nanotube, graphene, carbon black, or the like can be used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferable because it may have a spherical shape. Moreover, MCMB may be preferable because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery using graphite can have a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

As the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of high charging and discharging capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the composite nitride of lithium and a transition metal can be used as the negative electrode active material by extracting the lithium ions contained in the positive electrode active material in advance.

Alternatively, a material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For a conductive additive and a binder that can be included in the negative electrode active material layer, materials similar to those for the conductive additive and the binder that can be included in the positive electrode active material layer can be used.

### <Negative Electrode Current Collector>

For a negative electrode current collector, copper or the like can be used in addition to a material similar to that for a positive electrode current collector. Note that a material that is not alloyed with carrier ions of lithium or the like is preferably used for the negative electrode current collector.

### [Electrolyte]

As an electrolyte, for example, one kind of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more kinds of these can be used in an appropriate combination at an appropriate ratio.

The electrolyte preferably contains fluorine. As an electrolyte containing fluorine, for example, an electrolyte containing one kind or two or more kinds of fluorinated cyclic carbonates and lithium ions can be used. The fluorinated cyclic carbonate can improve nonflammability and increase the safety of the lithium-ion secondary battery.

As the fluorinated cyclic carbonate, ethylene fluoride carbonate such as monofluoroethylene carbonate (fluoroethylene carbonate, FEC, or F1EC), difluoroethylene carbonate (DFEC or F2EC), trifluoroethylene carbonate (F3EC), or tetrafluoroethylene carbonate (F4EC) can be used, for example. Note that DFEC includes an isomer such as cis-4,5 or trans-4,5. For operation at low temperatures, as the electrolyte, it is important to use one kind or two or more kinds of fluorinated cyclic carbonates to solvate a lithium ion and transport the lithium ion in the electrolyte included in the electrode in charging and discharging. When the fluorinated cyclic carbonate is not used as a small amount of additive but contributes to transportation of a lithium ion in charging and discharging, operation can be performed at low temperatures.

The use of the fluorinated cyclic carbonate for the electrolyte can reduce desolvation energy that is necessary for the solvated lithium ion in the electrolyte of the electrode to enter an active material particle. The reduction in the desolvation energy can facilitate insertion or extraction of a lithium ion into or from the active material particle even in a low-temperature range. Although a lithium ion sometimes moves remaining in the solvated state, a hopping phenomenon in which coordinated solvent molecules are interchanged occurs in some cases. When desolvation from a lithium ion becomes easy, movement owing to the hopping phenomenon is facilitated and the lithium ion may easily move.

In some cases, a plurality of solvated lithium ions form a cluster in the electrolyte and the cluster moves in the negative electrode, between the positive electrode and the negative electrode, or in the positive electrode, for example.

An example of the fluorinated cyclic carbonate is shown below.

The monofluoroethylene carbonate (FEC) is represented by Formula (1) below.

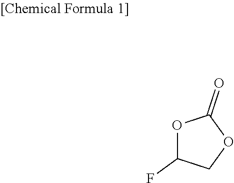

The tetrafluoroethylene carbonate (F4EC) is represented by Formula (2) below.

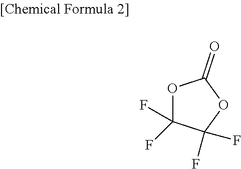

The difluoroethylene carbonate (DFEC) is represented by Formula (3) below.

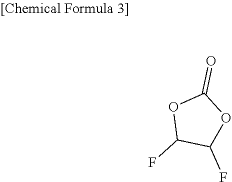

Alternatively, the use of one or more ionic liquids (room temperature molten salts) that are incombustible and less likely to volatile as the solvent of the electrolyte can prevent a secondary battery from exploding or catching fire even when the secondary battery internally shorts out or the internal region temperature increases owing to overcharging or the like. In the case where the separator is impregnated with the ionic liquid, a secondary battery that is less likely to burn can be obtained. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As an ionic liquid containing imidazolium cations, an ionic liquid represented by General Formula (G1) below can be used, for example. In General Formula (G1), R¹ represents an alkyl group having 1 to 4 carbon atoms, R² to R⁴ each independently represent a hydrogen atom or an alkyl group having 1 to 4 carbon atoms, and R⁵ represents an alkyl group or a main chain composed of two or more atoms selected from C, O, Si, N, S, and P atoms. A substituent may be introduced into the main chain represented by R⁵. Examples of the substituent to be introduced include an alkyl group and an alkoxy group.

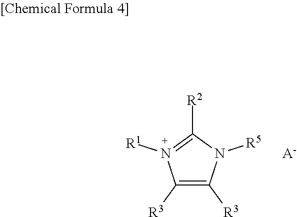

Examples of a cation represented by General Formula (G1) include a 1-ethyl-3-methylimidazolium cation, a 1-butyl-3-methylimidazolium cation, a 1-methyl-3-(propoxyethyl) imidazolium cation, and a 1-hexyl-3-methylimidazolium cation.

As an ionic liquid containing pyridinium cations, an ionic liquid represented by General Formula (G2) below may be used, for example. In General Formula (G2), R⁶ represents an alkyl group or a main chain composed of two or more atoms selected from C, O, Si, N, S, and P atoms, and R⁷ to R¹¹ each independently represent a hydrogen atom or an alkyl group having 1 to 4 carbon atoms. A substituent may be introduced into the main chain represented by R⁶. Examples of the substituent to be introduced include an alkyl group and an alkoxy group.

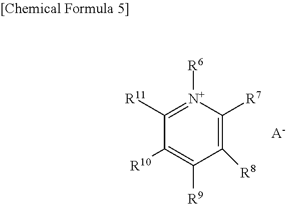

As an ionic liquid containing quaternary ammonium cations, an ionic liquid represented by General Formula (G3), (G4), (G5), or (G6) below can be used, for example.

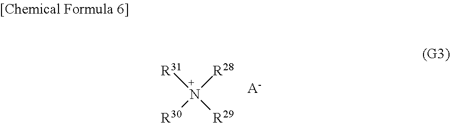

In General Formula (G3), R²⁸ to R³¹ each independently represent any of an alkyl group having 1 to 20 carbon atoms, a methoxy group, a methoxymethyl group, a methoxyethyl group, or a hydrogen atom.

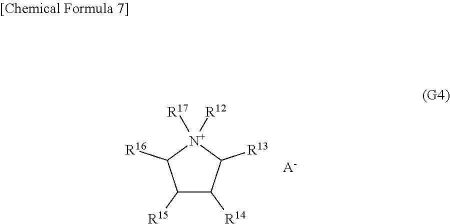

In General Formula (G4), R¹² to R¹⁷ each independently represent any of an alkyl group having 1 to 20 carbon atoms, a methoxy group, a methoxymethyl group, a methoxyethyl group, or a hydrogen atom. An example of a cation represented by General Formula (G4) is a 1-methyl-1-propylpyrrolidinium cation.

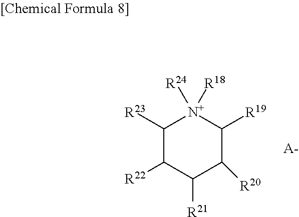

In General Formula (G5), R¹⁸ to R²⁴ each independently represent any of an alkyl group having 1 to 20 carbon atoms, a methoxy group, a methoxymethyl group, a methoxyethyl group, or a hydrogen atom. Examples of a cation represented by General Formula (G5) include an N-methyl-N-propylpiperidinium cation and a 1,3-dimethyl-1-propylpiperidinium cation.

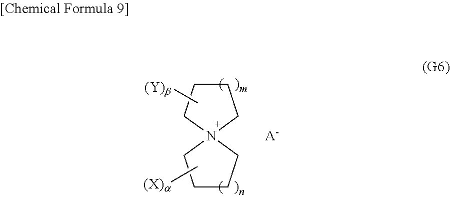

In General Formula (G6), n and m are greater than or equal to 1 and less than or equal to 3. Assume that a is greater than or equal to 0 and less than or equal to 6. When n is 1, α is greater than or equal to 0 and less than or equal to 4. When n is 2, α is greater than or equal to 0 and less than or equal to 5. When n is 3, α is greater than or equal to 0 and less than or equal to 6. Assume that β is greater than or equal to 0 and less than or equal to 6. When m is 1, β is greater than or equal to 0 and less than or equal to 4. When m is 2, β is greater than or equal to 0 and less than or equal to 5. When m is 3, β is greater than or equal to 0 and less than or equal to 6. Note that “α or β is 0” means “unsubstituted”. The case where both α and β are 0 is excluded. X or Y represents a substituent such as a straight-chain or side-chain alkyl group having 1 to 4 carbon atoms, a straight-chain or side-chain alkoxy group having 1 to 4 carbon atoms, or a straight-chain or side-chain alkoxyalkyl group having 1 to 4 carbon atoms.

As an ionic liquid containing tertiary sulfonium cations, an ionic liquid represented by General Formula (G7) below can be used, for example. In General Formula (G7), R²⁵ to R²⁷ each independently represent a hydrogen atom, an alkyl group having 1 to 4 carbon atoms, or a phenyl group. Alternatively, as R²⁵ to R²⁷, a main chain composed of two or more atoms selected from C, O, Si, N, S, and P atoms may be used.

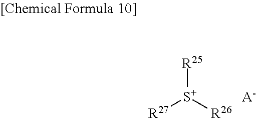

As an ionic liquid containing quaternary phosphonium cations, an ionic liquid represented by General Formula (G8) below can be used, for example. In General Formula (G8), R³² to R³⁵ each independently represent a hydrogen atom, an alkyl group having 1 to 4 carbon atoms, or a phenyl group. Alternatively, as R³² to R³⁵, a main chain composed of two or more atoms selected from C, O, Si, N, S, and P atoms may be used.

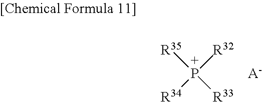

As A⁻ shown in General Formulae (G1) to (G8), one or more of a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion can be used.

As a monovalent amide-based anion, (CₙF₂ₙ₊₁SO₂)₂N⁻ (n is greater than or equal to 0 and less than or equal to 3) can be used, and as a monovalent cyclic amide-based anion, (CF₂SO₂)₂N⁻ or the like can be used. As a monovalent methide-based anion, (CₙF₂ₙ₊₁SO₂)₃C⁻ (n is greater than or equal to 0 and less than or equal to 3) can be used, and as a monovalent cyclic methide-based anion, (CF₂SO₂)₂C⁻(CF₃SO₂) or the like can be used. As a fluoroalkyl sulfonic acid anion, (CₘF₂ₘ₊₁SO₃)⁻ (m is greater than or equal to 0 and less than or equal to 4) or the like can be given. As a fluoroalkylborate anion, {BFₙ(CₘHₖF₂ₘ₊₁₋ₖ)₄₋ₙ}⁻ (n is greater than or equal to 0 and less than or equal to 3, m is greater than or equal to 1 and less than or equal to 4, and k is greater than or equal to 0 and less than or equal to 2m) or the like can be given. As a fluoroalkylphosphate anion, {PFₙ(CₘHₖF₂ₘ₊₁₋ₖ)₆₋ₙ}⁻ (n is greater than or equal to 0 and less than or equal to 5, m is greater than or equal to 1 and less than or equal to 4, and k is greater than or equal to 0 and less than or equal to 2m) or the like can be given.

As a monovalent amide-based anion, one or more of a bis(fluorosulfonyl)amide anion and a bis(trifluoromethanesulfonyl)amide anion can be used, for example.

An ionic liquid may contain one or more of a hexafluorophosphate anion and a tetrafluoroborate anion.

Hereinafter, an anion represented by (FSO₂)₂N⁻ is sometimes expressed by an FSA anion, and an anion represented by (CF₃SO₂)₂N⁻ is sometimes expressed by a TFSA anion.

The secondary battery of one embodiment of the present invention includes, as a carrier ion, one or more of an alkali metal ion such as a sodium ion or a potassium ion and an alkaline earth metal ion such as a calcium ion, a strontium ion, a barium ion, a beryllium ion, or a magnesium ion, for example.

In the case where a lithium ion is used as a carrier ion, for example, an electrolyte contains lithium salt. As the lithium salt, for example, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), or LiN(C₂F₅SO₂)₂ can be used.

In this specification, an electrolyte is a general term of a solid material, a liquid material, a semi-solid-state electrolyte material, and the like.

Deterioration is likely to occur at an interface existing in a secondary battery, e.g., an interface between an active material and an electrolyte. The secondary battery of one embodiment of the present invention includes the electrolyte containing fluorine, which can prevent deterioration that might occur at an interface between the active material and the electrolyte, typically, alteration of the electrolyte or a higher viscosity of the electrolyte. DFEC to which two fluorine atoms are bonded and F4EC to which four fluorine atoms are bonded have low viscosities and are coordinated to lithium more weakly as compared with FEC to which one fluorine atom is bonded. Accordingly, it is possible to reduce attachment of a decomposition product with a high viscosity to an active material particle. When a decomposition product with a high viscosity is attached to or clings to an active material particle, a lithium ion is less likely to move at an interface between active material particles. When a lithium ion is solvated by an electrolyte containing fluorine, generation of a decomposition product that is to be attached to the surface of the active material (the positive electrode active material or the negative electrode active material) is reduced. Moreover, the use of the electrolyte containing fluorine prevents attachment of a decomposition product, which can prevent generation and growth of a dendrite.

The use of the electrolyte containing fluorine as a main component is also a feature, and the amount of the electrolyte containing fluorine is higher than or equal to 5 volume % or higher than or equal to 10 volume %, preferably higher than or equal to 30 volume % and lower than or equal to 100 volume %.

In this specification, a main component of an electrolyte occupies higher than or equal to 5 volume % of the whole electrolyte of a secondary battery. Here, “higher than or equal to 5 volume % of the whole electrolyte of a secondary battery” refers to the proportion in the whole electrolyte that is measured during manufacture of the secondary battery. In the case where a secondary battery is disassembled after manufactured, the proportions of a plurality of kinds of electrolytes are difficult to quantify, but it is possible to judge whether one kind of organic compound occupies higher than or equal to 5 volume % of the whole electrolyte.

With use of the electrolyte containing fluorine, it is possible to provide a secondary battery that can operate in a wide temperature range, specifically, higher than or equal to −40° C. and lower than or equal to 150° C., preferably higher than or equal to −40° C. and lower than or equal to 85° C.

An additive such as vinylene carbonate, propane sultone (PS), tert-butylbenzene (TBB), lithium bis(oxalate) borate (LiBOB), or a dinitrile compound such as succinonitrile or adiponitrile may be added to the electrolyte. The concentration of the additive in the whole electrolyte is, for example, higher than or equal to 0.1 volume % and lower than 5 volume %.

The electrolyte may contain one or more aprotic organic solvents such as γ-butyrolactone, acetonitrile, dimethoxyethane, and tetrahydrofuran, in addition to the above.

When a gelled high-molecular material is contained in the electrolyte, safety against liquid leakage and the like is improved. Typical examples of gelled high-molecular materials include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO); PVdF; polyacrylonitrile; a copolymer containing any of them; and the like can be used. For example, PVdF-HFP, which is a copolymer of PVdF and hexafluoropropylene (HFP) can be used. The formed high-molecular material may have a porous shape.

### [Exterior Body]

For an exterior body included in the secondary battery, a metal material such as aluminum and/or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided as the outer surface of the exterior body over the metal thin film.

This embodiment can be used in appropriate combination with any of the other embodiments.

### Embodiment 2

In this embodiment, a method for manufacturing a secondary battery will be described.

### <Manufacturing Method 1 of Laminated Secondary Battery>

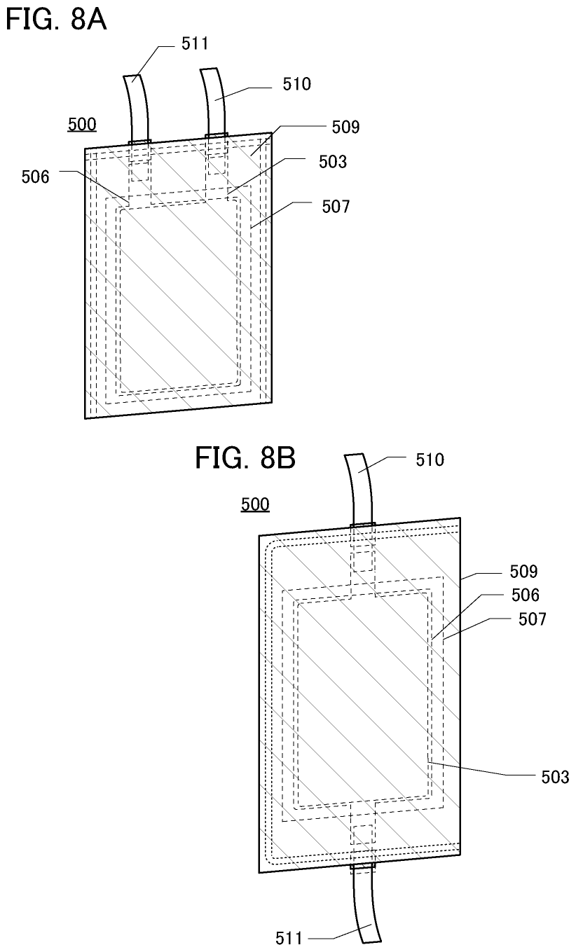

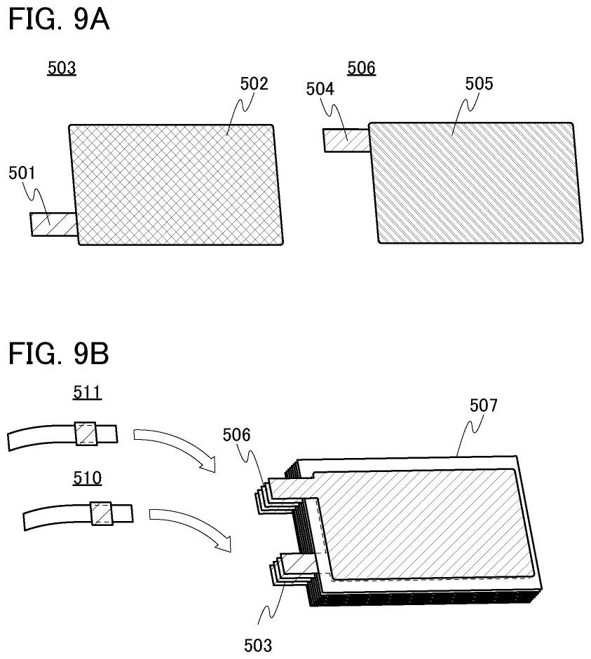

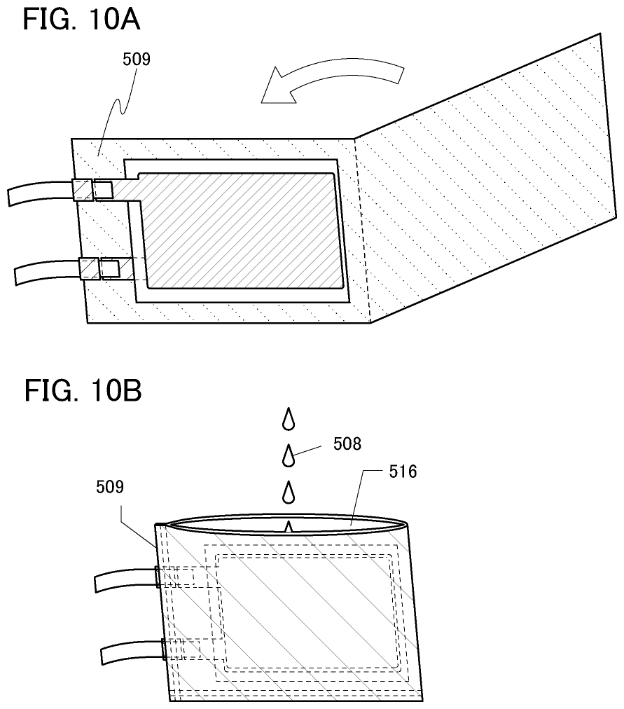

Here, an example of a method for manufacturing the laminated secondary battery whose external view is illustrated in FIG. 8A and FIG. 8B is described with reference to FIG. 9A and FIG. 9B, and FIG. 10A and FIG. 10B. Secondary batteries 500 illustrated in FIG. 8A and FIG. 8B each include the positive electrode 503, the negative electrode 506, the separator 507, an exterior body 509, a positive electrode lead electrode 510, and a negative electrode lead electrode 511.

First, the positive electrode 503, the negative electrode 506, and the separator 507 are prepared. FIG. 9A illustrates an example of the positive electrode 503 and the negative electrode 506. The positive electrode 503 includes the positive electrode active material layer 502 over the positive electrode current collector 501. The positive electrode 503 preferably includes a tab region where the positive electrode current collector 501 is exposed. The negative electrode 506 includes the negative electrode active material layer 505 over the negative electrode current collector 504. The negative electrode 506 preferably includes a tab region where the negative electrode current collector 504 is exposed.

Next, the negative electrode 506, the separator 507, and the positive electrode 503 are stacked. FIG. 9B illustrates the negative electrodes 506, the separators 507, and the positive electrodes 503 that are stacked. Here, an example in which 5 negative electrodes and 4 positive electrodes are used is illustrated. The stacked negative electrodes 506, separators 507, and positive electrodes 503 can also be referred to as a stack including the negative electrodes, the separators, and the positive electrodes.

Next, the tab regions of the positive electrodes 503 are bonded to each other, and the tab region of the positive electrode on the outermost surface and the positive electrode lead electrode 510 are bonded to each other. The bonding can be performed by ultrasonic welding, for example. In a similar manner, the tab regions of the negative electrodes 506 are bonded to each other, and the tab region of the negative electrode on the outermost surface and the negative electrode lead electrode 511 are bonded to each other.

Then, the negative electrodes 506, the separators 507, and the positive electrodes 503 are placed over the exterior body 509.

Subsequently, the exterior body 509 is folded along a portion shown by a dashed line, as illustrated in FIG. 10A. After that, the outer edges of the exterior body 509 are bonded to each other. The bonding can be performed by thermocompression bonding, for example. At this time, an unbonded region (hereinafter referred to as an inlet 516) is provided for part (or one side) of the exterior body 509 so that the electrolyte 508 can be introduced later.

Next, the electrolyte 508 is introduced into the exterior body 509 from the inlet 516 of the exterior body 509 as illustrated in FIG. 10B. The electrolyte 508 is preferably introduced in a reduced pressure atmosphere or in an inert atmosphere. Lastly, the inlet 516 is bonded. In this manner, the laminated secondary battery 500 can be manufactured.

In the above, the positive electrode lead electrode 510 and the negative electrode lead electrode 511 are drawn from the same side to the outside of the exterior body, so that the secondary battery 500 illustrated in FIG. 8A is manufactured. The secondary battery 500 illustrated in FIG. 8B can also be manufactured by drawing the positive electrode lead electrode 510 and the negative electrode lead electrode 511 from opposite sides to the outside of the exterior body.

### <Manufacturing Method 2 of Laminated Secondary Battery>

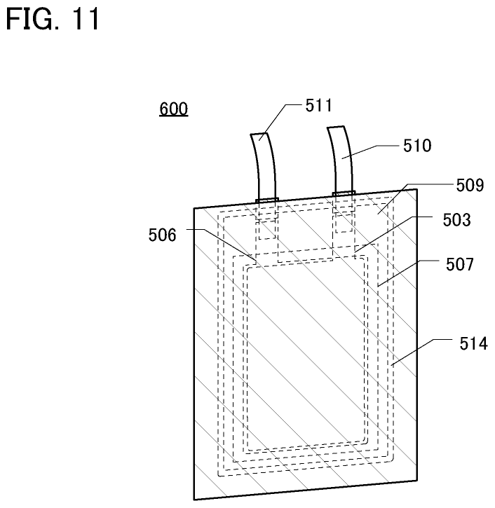

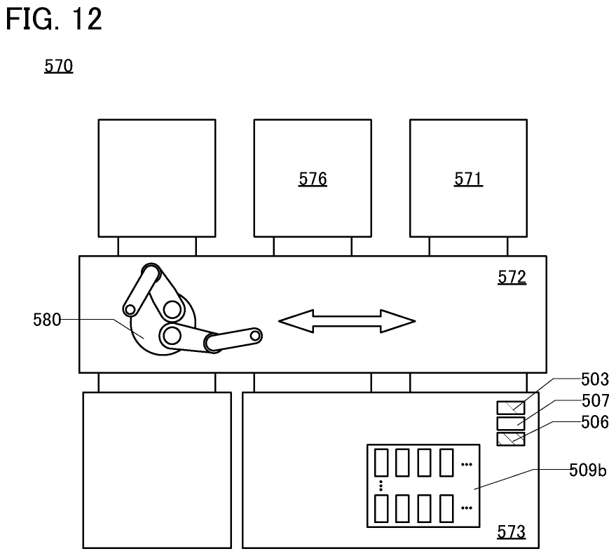

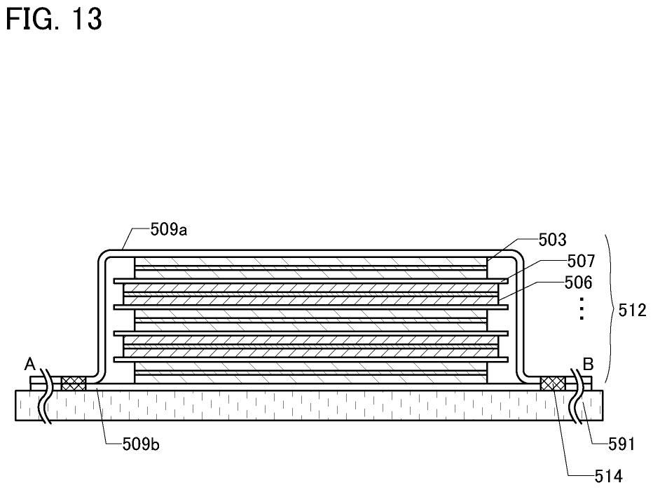

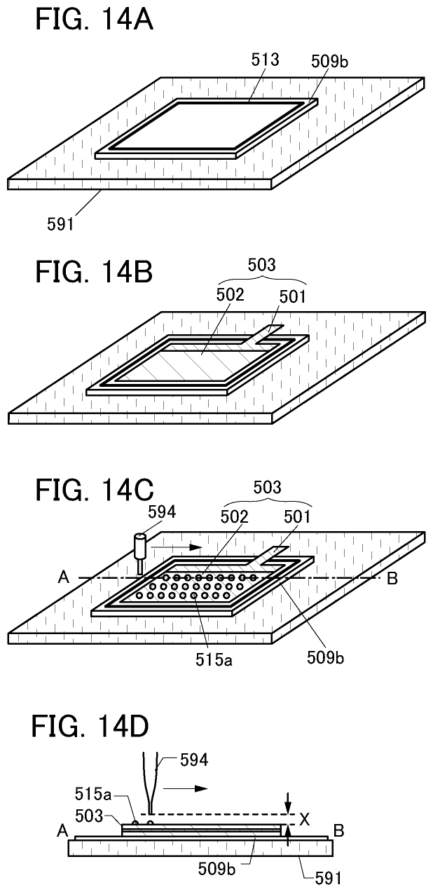

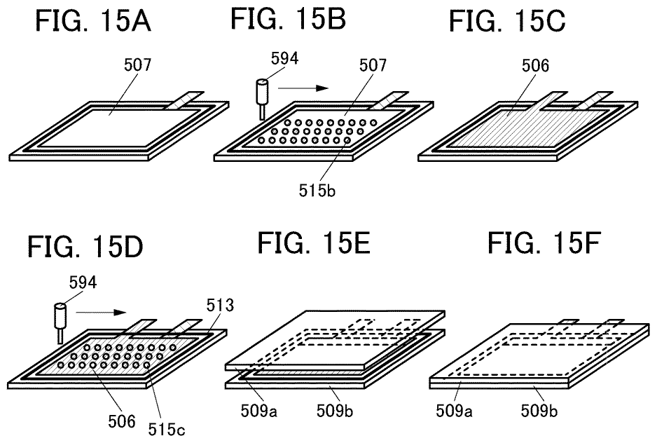

Next, an example of a method for manufacturing a secondary battery 600 whose external view is illustrated in FIG. 11 is described with reference to FIG. 12, FIG. 13, FIG. 14A to FIG. 14D, and FIG. 15A to FIG. 15F. The secondary battery 600 illustrated in FIG. 11 includes the positive electrode 503, the negative electrode 506, the separator 507, the exterior body 509, the positive electrode lead electrode 510, and the negative electrode lead electrode 511. The exterior body 509 is sealed in a region 514.

The laminated secondary battery 600 can be manufactured using, for example, a manufacturing apparatus illustrated in FIG. 12. A manufacturing apparatus 570 illustrated in FIG. 12 includes a component introduction chamber 571, a transfer chamber 572, a processing chamber 573, and a component extraction chamber 576. A structure can be employed in which each chamber is connected to a variety of exhaust mechanisms depending on usage. Alternatively, a structure can be employed in which each chamber is connected to a variety of gas supply mechanisms depending on usage. An inert gas is preferably supplied into the manufacturing apparatus 570 to inhibit entry of impurities into the manufacturing apparatus 570. Note that a gas that has been highly purified by a gas purifier before introduction into the manufacturing apparatus 570 is preferably used as the gas supplied into the manufacturing apparatus 570. The component introduction chamber 571 is a chamber for introducing a positive electrode, a separator, a negative electrode, an exterior body, and the like into the manufacturing apparatus 570. The transfer chamber 572 includes a transfer mechanism 580. The processing chamber 573 includes a stage and an electrolyte dripping mechanism. The component extraction chamber 576 is a chamber for extracting the manufactured secondary battery to the outside of the manufacturing apparatus 570.

A manufacturing process of the laminated secondary battery 600 is described below.

First, an exterior body 509b is placed over a stage 591 of the processing chamber 573, and the positive electrode 503 is placed over the exterior body 509b (FIG. 14A and FIG. 14B). Next, an electrolyte 515a is dripped from a nozzle 594 onto the positive electrode 503 (FIG. 14C and FIG. 14D). FIG. 14D is a cross section taken along dashed-dotted line A-B of FIG. 14C. Note that the description of the stage 591 is sometimes omitted to avoid complexity of the diagram. As a dripping method, any one of a dispensing method, a spraying method, an inkjet method, and the like can be used, for example. In addition, an ODF (One Drop Fill) method can be used for dripping the electrolyte.

With movement of the nozzle 594, the electrolyte 515a can be dripped on the entire surface of the positive electrode 503. Alternatively, with movement of the stage 591, the electrolyte 515a may be dripped on the entire surface of the positive electrode 503.

It is preferable to drip the electrolyte from a position whose shortest distance from a surface where the electrolyte is dripped is greater than 0 mm and less than or equal to 1 mm.

The viscosity of the electrolyte dripped from the nozzle or the like is preferably adjusted as appropriate. When the viscosity of the whole electrolyte falls within the range from 0.3 mPa·s to 1000 mPa·s at room temperature (25° C.), the electrolyte can be dripped from the nozzle.

Since the viscosity of the electrolyte changes depending on the temperature of the electrolyte, the temperature of the electrolyte to be dripped is preferably adjusted as appropriate. The temperature of the electrolyte is preferably higher than or equal to the melting point, lower than or equal to the boiling point, or lower than or equal to the flash point of the electrolyte.

Next, the separator 507 is placed over the positive electrode 503 to overlap with the entire surface of the positive electrode 503 (FIG. 15A). Next, an electrolyte 515b is dripped onto the separator 507 with the use of the nozzle 594 (FIG. 15B). Then, the negative electrode 506 is placed over the separator 507 (FIG. 15C). The negative electrode 506 is placed over the separator 507 so as not to protrude from the separator 507 in a top view. Next, an electrolyte 515c is dripped onto the negative electrode 506 with the use of the nozzle 594 (FIG. 15D). After that, a stack of the positive electrode 503, the separator 507, and the negative electrode 506 is further stacked, whereby a stack 512 illustrated in FIG. 13 can be manufactured. Next, the positive electrodes 503, the separators 507, and the negative electrodes 506 are sealed with an exterior body 509a and the exterior body 509b (FIG. 15E and FIG. 15F).

Multiple formation can be performed by placing a plurality of stacks 512 on the exterior body 509b. The stacks 512 are each sealed with the exterior bodyies 509a and 509b in the region 514 to surround an active material layer, then divided by the outside of the region 514, whereby a plurality of secondary batteries can be individually separated.

For the sealing, first, a frame-like resin layer 513 is formed over the exterior body 509b. Next, at least part of the resin layer 513 is irradiated with light under reduced pressure, whereby at least part of the resin layer 513 is cured. Next, sealing is performed in the region 514 by thermocompression bonding or welding under atmospheric pressure. Furthermore, only sealing by thermocompression bonding or welding may be performed without performing the above-described sealing by light irradiation.

Although FIG. 11 illustrates an example in which four sides of the exterior body 509 are sealed (referred to as a four-side sealing in some cases); however, three sides of the exterior body 509 may be sealed (referred to as a three-side sealing in some cases) as illustrated in FIG. 8A and FIG. 8B.

Through the above steps, the laminated secondary battery 600 can be manufactured.

### <Other Secondary Batteries and Manufacturing Method 1 Thereof>

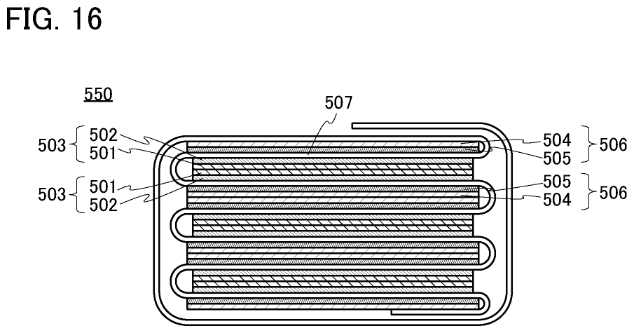

FIG. 16 illustrates an example of a cross-sectional view of a stack of one embodiment of the present invention. A stack 550 illustrated in FIG. 16 is manufactured by placing one folded separator between the positive electrode and the negative electrode.

In the stack 550, one separator 507 is folded a plurality of times to be sandwiched between the positive electrode active material layer 502 and the negative electrode active material layer 505. Since six positive electrodes 503 and six negative electrodes 506 are stacked in FIG. 16, the separator 507 is folded at least five times. The separator 507 is provided to be sandwiched between the positive electrode active material layer 502 and the negative electrode active material layer 505 and to have an extending portion folded such that the plurality of positive electrodes 503 and the plurality of negative electrodes 506 may be bound together with a tape or the like.

In the method for manufacturing the secondary battery of one embodiment of the present invention, an electrolyte can be dripped on the positive electrode 503 after the positive electrode 503 is placed. Similarly, after the negative electrode 506 is placed, an electrolyte can be dripped on the negative electrode 506. In the method for manufacturing the secondary battery of one embodiment of the present invention, an electrolyte can be dripped on the separator 507 before the separator is folded or after the folded separator 507 overlaps with the negative electrode 506 or the positive electrode 503. When an electrolyte is dripped on at least one of the negative electrode 506, the separator 507, and the positive electrode 503, the negative electrode 506, the separator 507, or the positive electrode 503 can be impregnated with the electrolyte.

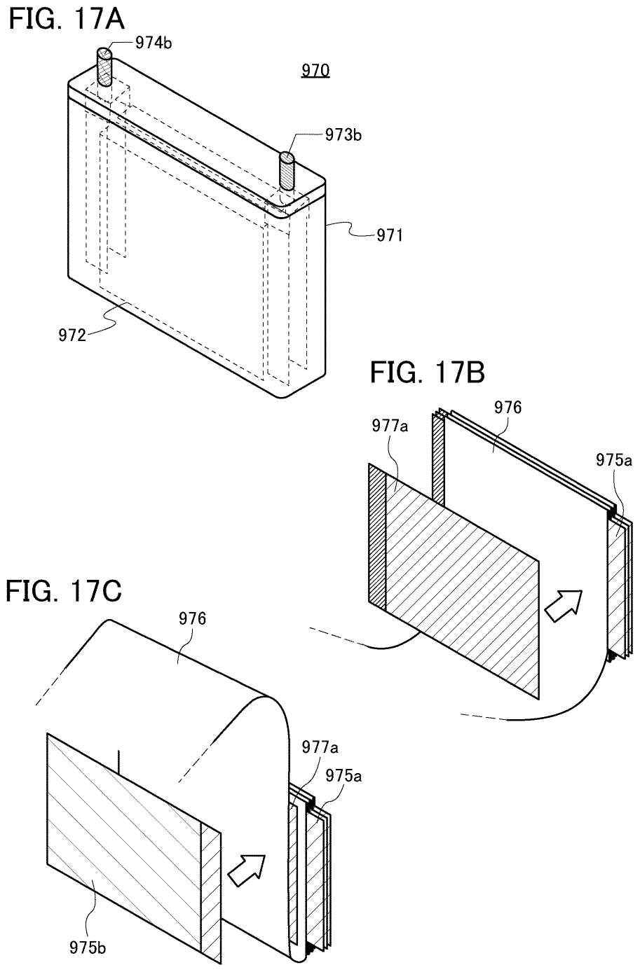

A secondary battery 970 illustrated in FIG. 17A includes a stack 972 inside a housing 971. A terminal 973b and a terminal 974b are electrically connected to the stack 972. At least part of the terminal 973b and at least part of the terminal 974b are exposed to the outside of the housing 971.

The stack 972 can have a stacked-layer structure of a positive electrode, a negative electrode, and a separator. Alternatively, the stack 972 can have a structure in which a positive electrode, a negative electrode, and a separator are wound, for example.

As the stack 972, the stack having the structure illustrated in FIG. 16 in which the separator is folded can be used, for example.

An example of a method for manufacturing the stack 972 will be described with reference to FIG. 17B and FIG. 17C.

First, as illustrated in FIG. 17B, a belt-like separator 976 overlaps with a positive electrode 975a, and a negative electrode 977a overlaps with the positive electrode 975a with the separator 976 therebetween. After that, the separator 976 is folded to overlap with the negative electrode 977a. Next, as illustrated in FIG. 17C, a positive electrode 975b overlaps with the negative electrode 977a with the separator 976 therebetween. In this manner, the positive electrodes and the negative electrodes are sequentially placed with the folded separator therebetween, whereby the stack 972 can be manufactured. A structure including the stack manufactured in the above manner is sometimes referred to as a “zigzag structure.”

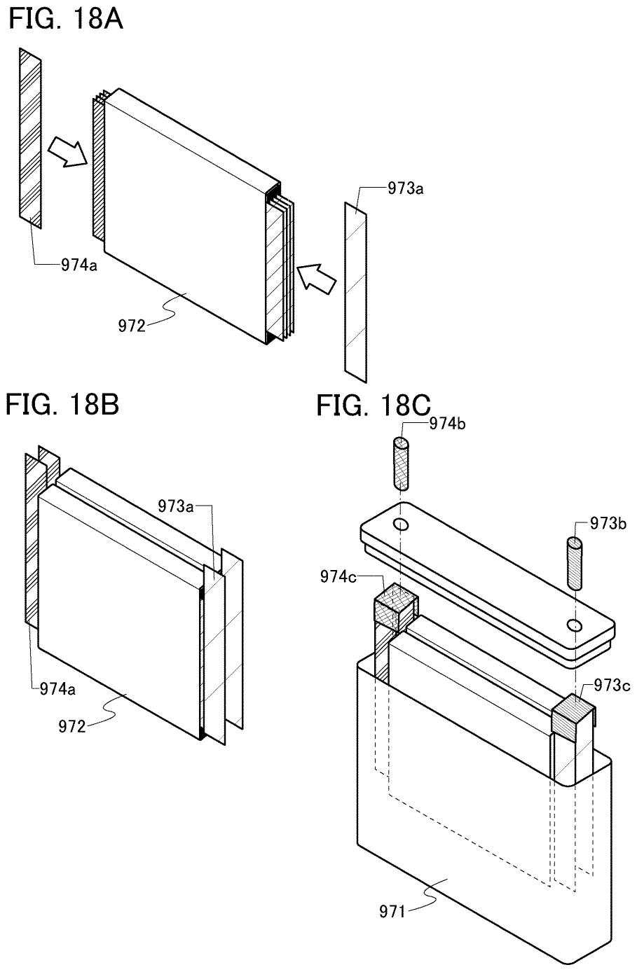

Next, an example of a method for manufacturing the secondary battery 970 will be described with reference to FIG. 18A to FIG. 18C.

First, as illustrated in FIG. 18A, a positive electrode lead electrode 973a is electrically connected to the positive electrodes included in the stack 972. Specifically, for example, the positive electrodes included in the stack 972 are provided with tab regions, and the tab regions and the positive electrode lead electrode 973a can be electrically connected to each other by welding or the like. In addition, a negative electrode lead electrode 974a is electrically connected to the negative electrodes included in the stack 972.

One stack 972 may be placed inside the housing 971 or a plurality of stacks 972 may be placed inside the housing 971. FIG. 18B illustrates an example of preparing two stacks 972.

Next, as illustrated in FIG. 18C, the prepared stacks 972 are stored in the housing 971, and the terminal 973b and the terminal 974b are inserted to seal the housing 971. It is preferable to electrically connect a conductor 973c to each of the positive electrode lead electrodes 973a included in the plurality of stacks 972. In addition, it is preferable to electrically connect a conductor 974c to each of the negative electrode lead electrodes 974a included in the plurality of stacks 972. The terminal 973b and the terminal 974b are electrically connected to the conductor 973c and the conductor 974c, respectively. Note that the conductor 973c may include a conductive region and an insulating region. In addition, the conductor 974c may include a conductive region and an insulating region.

For the housing 971, a metal material (e.g., aluminum or the like) can be used. In the case where a metal material is used for the housing 971, the surface is preferably coated with a resin or the like. Alternatively, a resin material can be used for the housing 971.

The housing 971 is preferably provided with a safety valve, an overcurrent protection element, or the like. A safety valve is a valve for releasing a gas, in order to prevent the battery from exploding, when the pressure inside the housing 971 reaches a predetermined pressure.

### <Other Secondary Batteries and Manufacturing Method 2 Thereof>

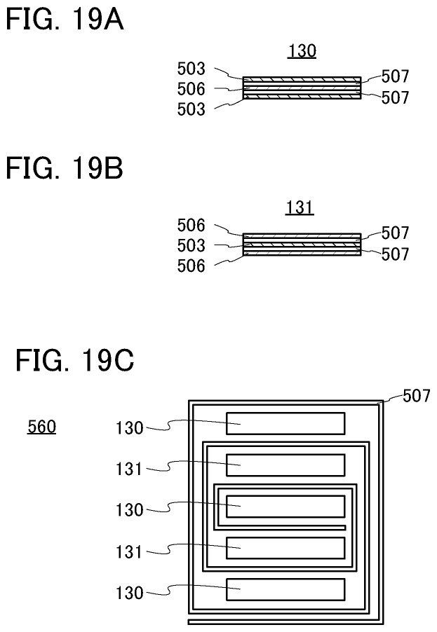

FIG. 19C illustrates an example of a cross-sectional view of a secondary battery of another embodiment of the present invention. A secondary battery 560 illustrated in FIG. 19C is manufactured using a stack 130 illustrated in FIG. 19A and a stack 131 illustrated in FIG. 19B. Note that FIG. 19C selectively illustrates the stack 130, the stack 131, and the separator 507 for clarity of the diagram.

As illustrated in FIG. 19A, in the stack 130, the positive electrode 503 including the positive electrode active material layers on both surfaces of the positive electrode current collector, the separator 507, the negative electrode 506 including the negative electrode active material layers on both surfaces of the negative electrode current collector, the separator 507, and the positive electrode 503 including the positive electrode active material layers on both surfaces of the positive electrode current collector are stacked in this order.

As illustrated in FIG. 19B, in the stack 131, the negative electrode 506 including the negative electrode active material layers on both surfaces of the negative electrode current collector, the separator 507, the positive electrode 503 including the positive electrode active material layers on both surfaces of the positive electrode current collector, the separator 507, and the negative electrode 506 including the negative electrode active material layers on both surfaces of the negative electrode current collector are stacked in this order.

The method for manufacturing the secondary battery of one embodiment of the present invention can be used for manufacturing the stacks. Specifically, in order to manufacture the stacks, an electrolyte is dripped on at least one of the negative electrode 506, the separator 507, and the positive electrode 503 at the time of stacking the negative electrode 506, the separator 507, and the positive electrode 503. Dripping a plurality of drops of the electrolyte enables the negative electrode 506, the separator 507, or the positive electrode 503 to be impregnated with the electrolyte.

As illustrated in FIG. 19C, the plurality of stacks 130 and the plurality of stacks 131 are covered with the wound separator 507.

In the method for manufacturing the secondary battery of one embodiment of the present invention, an electrolyte can be dripped on the stacks 130 after the stacks 130 are placed. Similarly, after the stacks 131 are placed, an electrolyte can be dripped on the stacks 131. In addition, an electrolyte can be dripped on the separator 507 before the separator 507 is folded or after the folded separator 507 overlaps with the stacks. Dripping a plurality of drops of the electrolyte enables the stacks 130, the stacks 131, or the separator 507 to be impregnated with the electrolyte.

### <Other Secondary Batteries and Manufacturing Method 3 Thereof>

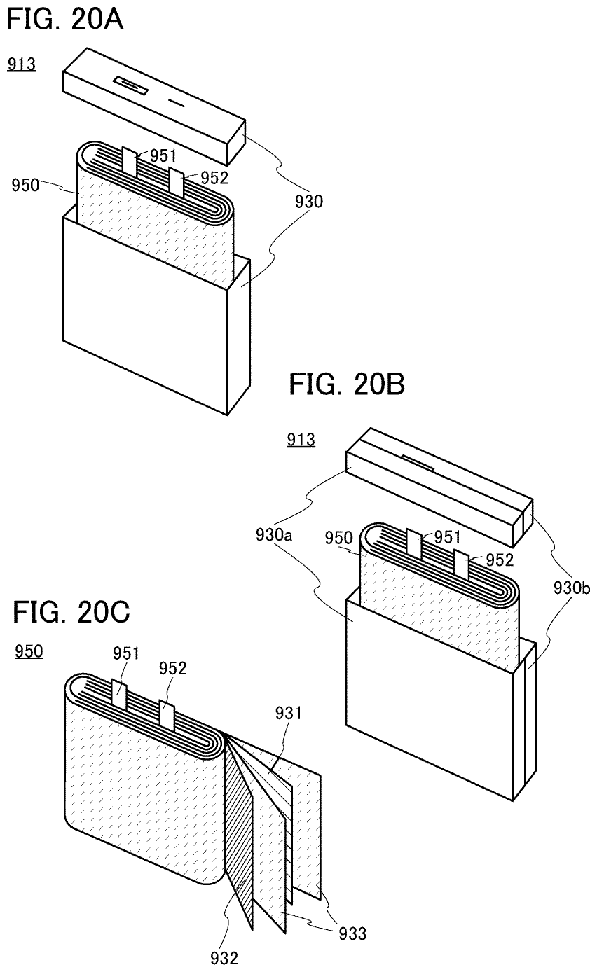

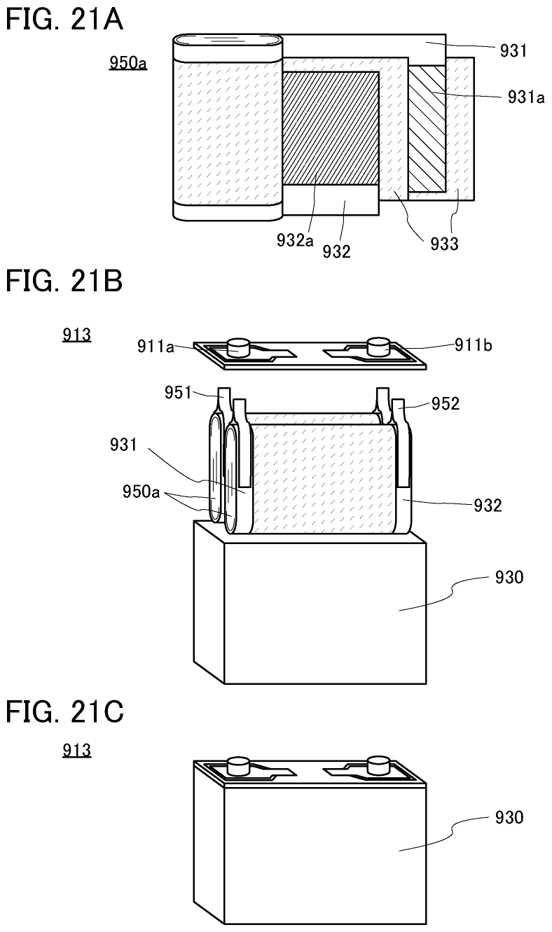

A secondary battery of another embodiment of the present invention will be described with reference to FIG. 20 and FIG. 21. The secondary battery described here can be referred to as a wound secondary battery or the like.

A secondary battery 913 illustrated in FIG. 20A includes a wound body 950 provided with a terminal 951 and a terminal 952 inside a housing 930. The wound body 950 is immersed in an electrolyte inside the housing 930. The terminal 952 is in contact with the housing 930, and the use of an insulator or the like prevents contact between the terminal 951 and the housing 930. Note that in FIG. 20A, the housing 930 divided into two pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 20B, the housing 930 illustrated in FIG. 20A may be formed using a plurality of materials. For example, in the secondary battery 913 illustrated in FIG. 20B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field from the secondary battery 913 can be inhibited. When an electric field is not significantly blocked by the housing 930a, an antenna may be provided inside the housing 930a. For the housing 930b, a metal material can be used, for example.

In addition, FIG. 20C illustrates the structure of the wound body 950. The wound body 950 includes a negative electrode 931, a positive electrode 932, and separators 933. The wound body 950 is obtained by winding a sheet of a stack in which the negative electrode 931 overlaps with the positive electrode 932 with the separator 933 provided therebetween. Note that a plurality of stacks each including the negative electrode 931, the positive electrode 932, and the separator 933 may be further stacked.

In the method for manufacturing the secondary battery of one embodiment of the present invention, an electrolyte is dripped on at least one of the negative electrode 931, the separator 933, and the positive electrode 932 at the time of stacking the negative electrode 931, the separator 933, and the positive electrode 932. That is, an electrolyte is preferably dripped before the sheet of the stack is wound. Dripping a plurality of drops of the electrolyte enables the negative electrode 931, the separator 933, or the positive electrode 932 to be impregnated with the electrolyte.

As illustrated in FIG. 21A, the secondary battery 913 may include a wound body 950a. The wound body 950a illustrated in FIG. 21A includes the negative electrode 931, the positive electrode 932, and the separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 21B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 21C, the wound body 950a and an electrolyte are covered with the housing 930, whereby the secondary battery 913 is completed. The housing 930 is preferably provided with a safety valve, an overcurrent protection element, and the like. In order to prevent the battery from exploding, a safety valve is temporarily released only when the internal pressure of the housing 930 exceeds a predetermined pressure.

As illustrated in FIG. 21B, the secondary battery 913 may include a plurality of wound bodies 950a. The use of the plurality of wound bodies 950a enables the secondary battery 913 to have higher charging and discharging capacity.

This embodiment can be combined with the other embodiments as appropriate.

### Embodiment 3

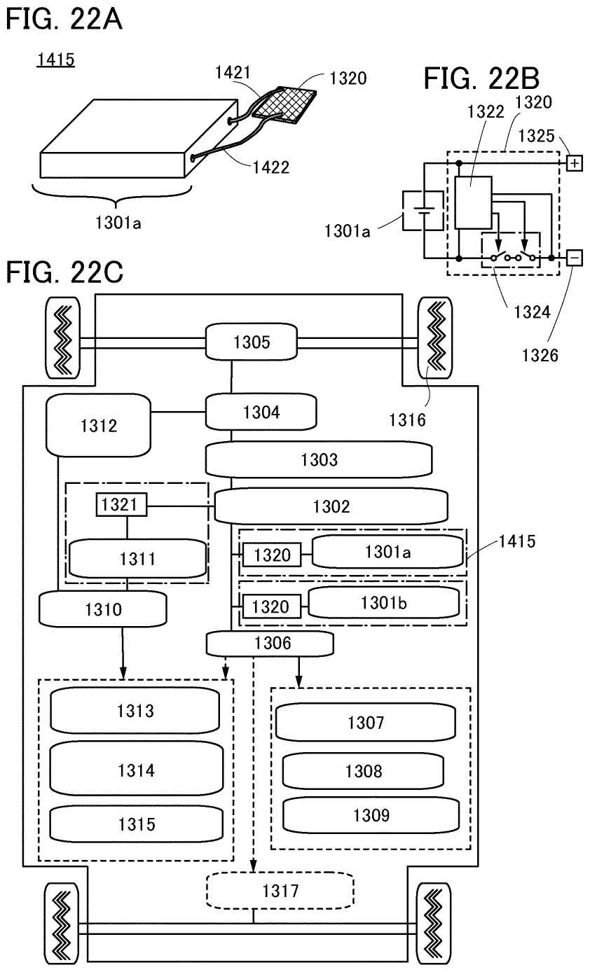

In this embodiment, application examples of the secondary battery of one embodiment of the present invention will be described with reference to FIG. 22 to FIG. 31.

### [Vehicle]

First, an example in which the secondary battery of one embodiment of the present invention is used in an electric vehicle (EV) will be described.

FIG. 22C is a block diagram of a vehicle including a motor. The electric vehicle is provided with first batteries 1301a and 1301b as main secondary batteries for driving and a second battery 1311 that supplies electric power to an inverter 1312 for starting a motor 1304. The second battery 1311 is also referred to as a cranking battery or a starter battery. The second battery 1311 only needs high output and high capacity is not so much needed; the capacity of the second battery 1311 is lower than that of the first batteries 1301a and 1301b.

For example, as one or both of the first batteries 1301a and 1301b, the secondary battery manufactured by the method for manufacturing the secondary battery of one embodiment of the present invention can be used.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (for a high-voltage system) (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (for a low-voltage system) (such as an audio 1313, power windows 1314, and lamps 1315) through a DCDC circuit 1310.

The first battery 1301a will be described with reference to FIG. 22A.

FIG. 22A illustrates an example of a large battery pack 1415. One electrode of the battery pack 1415 is electrically connected to a control circuit portion 1320 through a wiring 1421. The other electrode is electrically connected to the control circuit portion 1320 through a wiring 1422. Note that the battery pack may have a structure in which a plurality of secondary batteries are connected in series.

The control circuit portion 1320 may include a memory circuit including a transistor using an oxide semiconductor. A charging control circuit or a battery control system that includes a memory circuit including a transistor using an oxide semiconductor may be referred to as a BTOS (Battery operating system or Battery oxide semiconductor).

The control circuit portion 1320 senses a terminal voltage of the secondary battery and controls the charging and discharging state of the secondary battery. For example, to prevent overcharging, an output transistor of a charging circuit and an interruption switch can be turned off substantially at the same time.

FIG. 22B illustrates an example of a block diagram of the battery pack 1415 illustrated in FIG. 22A.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, or the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging or overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charging and discharging path. The control circuit portion 1320 includes an external terminal 1325 (+IN) and an external terminal 1326 (−IN).

The switch portion 1324 can be formed by a combination of n-channel transistors and/or p-channel transistors. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOₓ (gallium oxide, where x is a real number greater than 0), or the like. A memory element using an OS transistor can be freely placed by being stacked over a circuit using a Si transistor, for example; hence, integration can be easy. Furthermore, an OS transistor can be manufactured with a manufacturing apparatus similar to that for a Si transistor and thus can be manufactured at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage.

In this embodiment, an example in which a lithium-ion secondary battery is used as both the first battery 1301a and the second battery 1311 is described. As the second battery 1311, a lead storage battery, an all-solid-state battery, or an electric double layer capacitor may be used.

Regenerative energy generated by rolling of tires 1316 is transmitted to the motor 1304 through a gear 1305, and is stored in the second battery 1311 from a motor controller 1303 or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charging voltage, charging current, and the like of the first batteries 1301a and 1301b. The battery controller 1302 can set charging conditions in accordance with charging characteristics of a secondary battery to be used, so that fast charging can be performed.

Although not illustrated, when the electric vehicle is connected to an external charger, an outlet of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

Next, examples in which the secondary battery of one embodiment of the present invention is mounted on a vehicle, typically a transport vehicle, will be described.

By mounting the secondary battery of one embodiment of the present invention on vehicles, next-generation clean energy vehicles such as hybrid vehicles (HVs), electric vehicles (EVs), and plug-in hybrid vehicles (PHVs) can be achieved. The secondary battery can also be mounted on transport vehicles such as agricultural machines such as electric tractors, motorized bicycles including motor-assisted bicycles, motorcycles, electric wheelchairs, electric carts, boats or ships, submarines, aircraft such as fixed-wing aircraft and rotary-wing aircraft, rockets, artificial satellites, space probes, planetary probes, and spacecraft. With the use of the method for manufacturing the secondary battery of one embodiment of the present invention, a large secondary battery can be provided. Thus, the secondary battery of one embodiment of the present invention can be suitably used in transport vehicles.

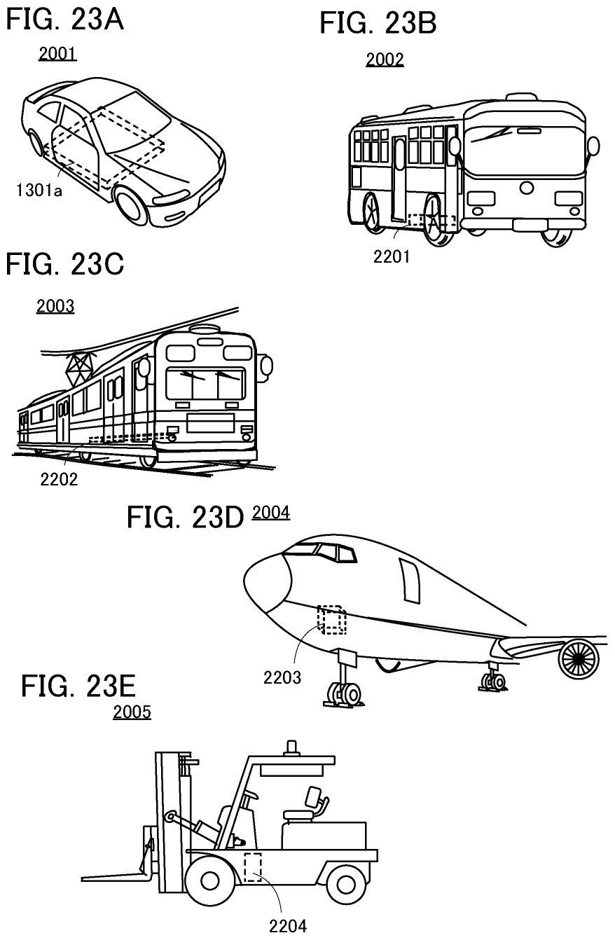

FIG. 23A to FIG. 23E illustrate transport vehicles each using the secondary battery of one embodiment of the present invention. An automobile 2001 illustrated in FIG. 23A is an electric vehicle that runs on an electric motor as a power source. Alternatively, the automobile 2001 is a hybrid vehicle that can appropriately select an electric motor or an engine as a driving power source. In the case where the secondary battery is mounted on the vehicle, the secondary battery is provided at one position or several positions. The automobile 2001 illustrated in FIG. 23A includes the battery pack 1415 illustrated in FIG. 22A. The battery pack 1415 includes a secondary battery module. The battery pack 1415 preferably further includes a charging control device that is electrically connected to the secondary battery module. The secondary battery module includes one or more secondary batteries.

The automobile 2001 can be charged when the secondary battery of the automobile 2001 receives electric power from external charging equipment through a plug-in system or a contactless charging system. In charging, a given method such as CHAdeMO (registered trademark) or Combined Charging System may be employed as a charging method, the standard of a connector, or the like as appropriate. The charging device may be a charging station provided in a commerce facility or a household power supply. For example, a plug-in technique enables an exterior power supply to charge a secondary battery mounted on the automobile 2001. The charging can be performed by converting AC electric power into DC electric power through a converter such as an ACDC converter.

Although not illustrated, the vehicle may include a power receiving device so that it can be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 23B illustrates a large transporter 2002 having a motor controlled by electric power, as an example of a transport vehicle. In a secondary battery module of the transporter 2002, a cell unit includes four secondary batteries with a voltage of 3.5 V or higher and 4.7 V or lower, and 48 cells are connected in series to have 170 V as the maximum voltage, for example. A battery pack 2201 has the same function as that in FIG. 23A except, for example, the number of secondary batteries configuring the secondary battery module; thus, the description is omitted.

FIG. 23C illustrates a large transport vehicle 2003 having a motor controlled by electricity as an example. In a secondary battery module of the transport vehicle 2003, 100 or more secondary batteries with a voltage of 3.5 V or higher and 4.7 V or lower are connected in series to have 600 V as the maximum voltage, for example. Thus, the secondary batteries are required to have few variations in the characteristics. With the use of the method for manufacturing the secondary battery of one embodiment of the present invention, a secondary battery with stable battery performance can be manufactured, and mass production at low cost is possible in view of the yield. A battery pack 2202 has the same function as the battery pack in FIG. 23A except, for example, the number of secondary batteries configuring the secondary battery module; thus, the description is omitted.

FIG. 23D illustrates an aircraft 2004 having a combustion engine as an example. The aircraft 2004 illustrated in FIG. 23D can be regarded as a kind of transport vehicles since it is provided with wheels for takeoff and landing, and has a battery pack 2203 that includes a charging control device and a secondary battery module configured by connecting a plurality of secondary batteries.

The secondary battery module of the aircraft 2004 has eight 4 V secondary batteries connected in series to have 32 V as the maximum voltage, for example. The battery pack 2203 has the same function as the battery pack in FIG. 23A except, for example, the number of secondary batteries configuring the secondary battery module; thus, the description is omitted.

FIG. 23E illustrates a transport vehicle 2005 for transporting a load as an example. The transport vehicle 2005 includes a motor controlled by electricity and executes various operations with use of electric power supplied from secondary batteries configuring a secondary battery module of a battery pack 2204. The transport vehicle 2005 is not limited to be operated by a human who rides thereon as a driver, an unmanned operation can be performed by CAN communication or the like. Although FIG. 23E illustrates a forklift, there is no particular limitation; a battery pack having the secondary battery of one embodiment of the present invention, the battery pack having a secondary battery of one embodiment of the present invention can be mounted on industrial machines that can be operated by CAN communication or the like, for example, an automatic transporter, a working robot, or a small construction machinery.

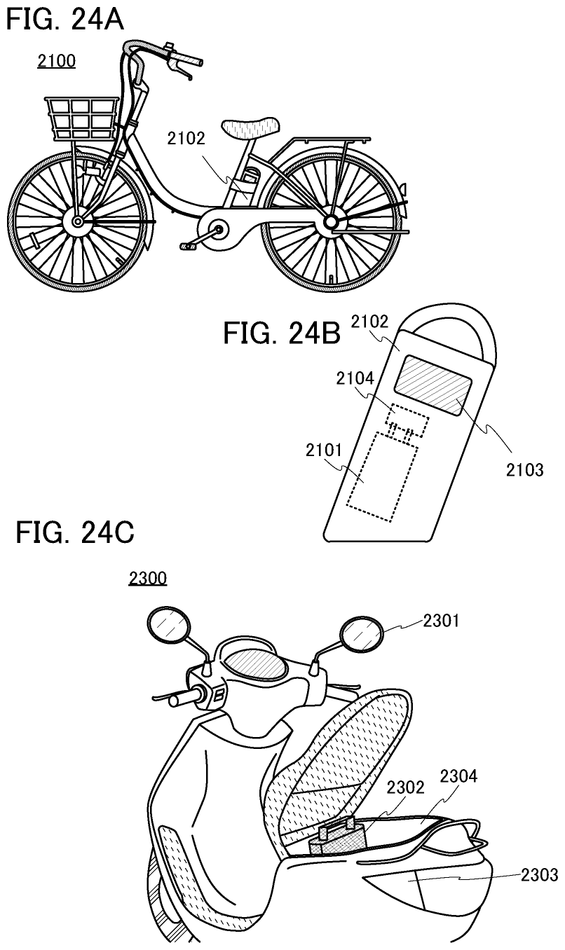

FIG. 24A illustrates an example of an electric bicycle using the secondary battery of one embodiment of the present invention. The secondary battery of one embodiment of the present invention can be used for an electric bicycle 2100 illustrated in FIG. 24A. A power storage device 2102 illustrated in FIG. 24B includes a plurality of secondary batteries and a protection circuit, for example.

The electric bicycle 2100 includes the power storage device 2102. The power storage device 2102 can supply electricity to a motor that assists a driver. The power storage device 2102 is portable, and FIG. 24B illustrates the state where the power storage device 2102 is detached from the bicycle. A plurality of secondary batteries 2101 of one embodiment of the present invention are incorporated in the power storage device 2102, and the remaining battery capacity and the like can be displayed on a display portion 2103. The power storage device 2102 includes a control circuit 2104 capable of charge control or anomaly detection for the secondary battery, which is exemplified in one embodiment of the present invention. The control circuit 2104 is electrically connected to a positive electrode and a negative electrode of the secondary battery 2101. Alternatively, a small solid-state secondary battery may be provided in the control circuit 2104. When the small solid-state secondary battery is provided in the control circuit 2104, electric power can be supplied to store data in a memory circuit included in the control circuit 2104 for a long time. When the small solid-state secondary battery is used in combination with a secondary battery whose positive electrode active material of one embodiment of the present invention, the synergy on safety can be obtained. The secondary battery including the positive electrode active material of one embodiment of the present invention in the positive electrode and the control circuit 2104 can greatly contribute to elimination of accidents due to secondary batteries, such as fires.

FIG. 24C illustrates an example of a motorcycle including the secondary battery of one embodiment of the present invention. A motor scooter 2300 illustrated in FIG. 24C includes a power storage device 2302, side mirrors 2301, and indicator lights 2303. The power storage device 2302 can supply electricity to the indicator lights 2303. The power storage device 2302 including a plurality of secondary batteries including a positive electrode using the positive electrode active material of one embodiment of the present invention can have high capacity and contribute to a reduction in size. To improve safety, a protection circuit that prevents overcharging and/or overdischarging of the secondary battery may be electrically connected to the secondary battery.

In the motor scooter 2300 illustrated in FIG. 24C, the power storage device 2302 can be stored in an under-seat storage unit 2304. The power storage device 2302 can be stored in the under-seat storage unit 2304 even with a small size.

### [Building]

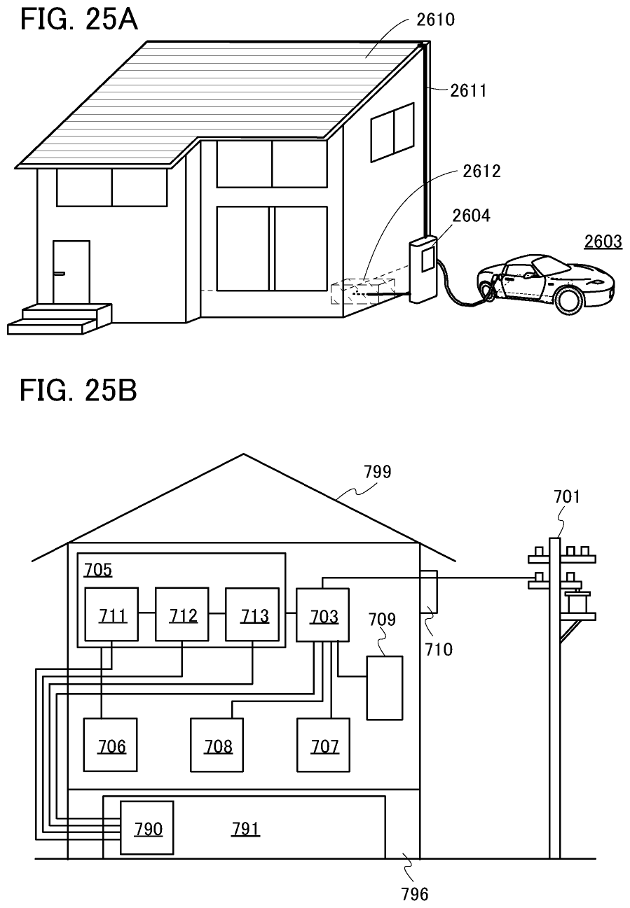

Next, examples in which the secondary battery of one embodiment of the present invention is mounted on a building will be described with reference to FIG. 25.

A house illustrated in FIG. 25A includes a power storage device 2612 including the secondary battery that has stable battery performance by using the method for manufacturing the secondary battery of one embodiment of the present invention and a solar panel 2610. The power storage device 2612 is electrically connected to the solar panel 2610 through a wiring 2611 or the like. The power storage device 2612 may be electrically connected to a ground-based charging device 2604. The power storage device 2612 can be charged with electric power generated by the solar panel 2610. A secondary battery included in a vehicle 2603 can be charged with the electric power stored in the power storage device 2612 through the charging device 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 as an uninterruptible power source, electronic devices can be used even when electric power cannot be supplied from a commercial power source due to power failure or the like.

FIG. 25B illustrates an example of a power storage device of one embodiment of the present invention. As illustrated in FIG. 25B, a large power storage device 791 obtained by the method for manufacturing the secondary battery of one embodiment of the present invention is provided in an underfloor space 796 of a building 799.

The power storage device 791 is provided with a control device 790, and the control device 790 is electrically connected to a distribution board 703, a power storage controller 705 (also referred to as a control device), an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electric device such as a TV or a personal computer. The power storage load 708 is, for example, an electric device such as a microwave oven, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charging and discharging plan of the power storage device 791 on the basis of the demand for electric power predicted by the predicting portion 712.

The amount of electric power consumed by the general load 707 and the power storage load 708 and measured by the measuring portion 711 can be checked with the indicator 706. It can be checked with an electric device such as a TV or a personal computer through the router 709. Furthermore, it can be checked with a portable electronic terminal such as a smartphone or a tablet through the router 709. With the indicator 706, the electric device, or the portable electronic terminal, for example, the demand for electric power depending on a time period (or per hour) that is predicted by the predicting portion 712 can be checked.

### [Electronic Device]

The secondary battery of one embodiment of the present invention can be used for one or both of an electronic device and a lighting device, for example. Examples of the electronic device include portable information terminals such as mobile phones, smartphones, or laptop computers; portable game machines; portable music players; digital cameras; and digital video cameras.

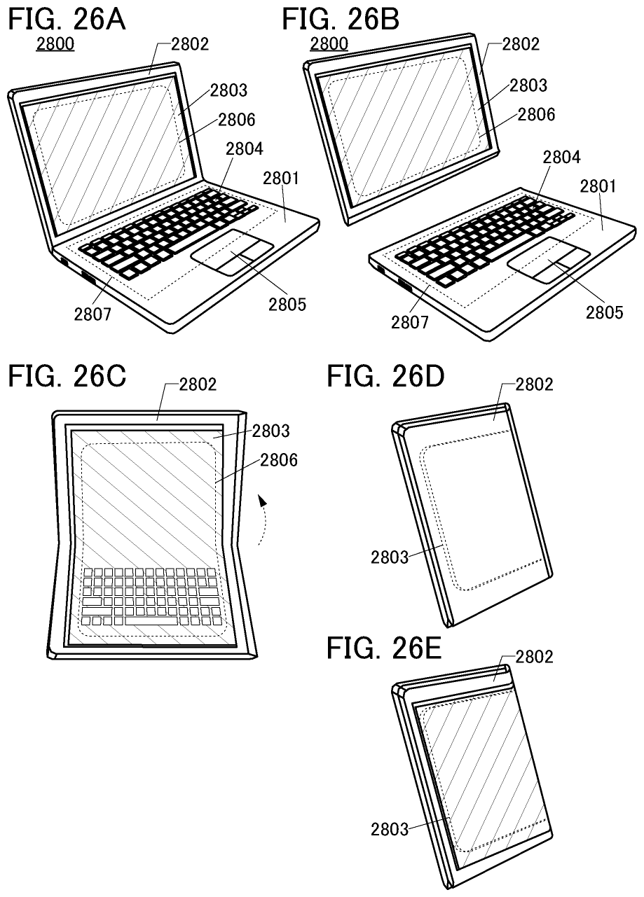

A personal computer 2800 illustrated in FIG. 26A includes a housing 2801, a housing 2802, a display portion 2803, a keyboard 2804, a pointing device 2805, and the like. A secondary battery 2807 is provided inside the housing 2801, and a secondary battery 2806 is provided inside the housing 2802. To improve safety, a protection circuit that prevents overcharging and/or overdischarging of the secondary battery 2807 may be electrically connected to the secondary battery 2807. A touch panel is used for the display portion 2803. As illustrated in FIG. 26B, the housing 2801 and the housing 2802 of the personal computer 2800 can be detached and the housing 2802 can be used alone as a tablet terminal.

The large secondary battery obtained by the method for manufacturing the secondary battery of one embodiment of the present invention can be used as one or both of the secondary battery 2806 and the secondary battery 2807. The shape of the secondary battery obtained by the method for manufacturing the secondary battery of one embodiment of the present invention can be changed freely by changing the shape of the exterior body. When the shapes of the secondary batteries 2806 and 2807 fit with the shapes of the housings 2801 and 2802, for example, the secondary batteries can have high capacity and thus the operating time of the personal computer 2800 can be lengthened. Moreover, the weight of the personal computer 2800 can be reduced.

A flexible display is used for the display portion 2803 of the housing 2802. As the secondary battery 2806, the large secondary battery obtained by the method for manufacturing the secondary battery of one embodiment of the present invention is used. With the use of a flexible film as the exterior body in the large secondary battery obtained by the method for manufacturing the secondary battery of one embodiment of the present invention, a bendable secondary battery can be obtained. Thus, as illustrated in FIG. 26C, the housing 2802 can be used while being bent. In that case, part of the display portion 2803 can be used as a keyboard as illustrated in FIG. 26C.

Furthermore, the housing 2802 can be folded such that the display portion 2803 is placed inward as illustrated in FIG. 26D, and the housing 2802 can be folded such that the display portion 2803 faces outward as illustrated in FIG. 26E.

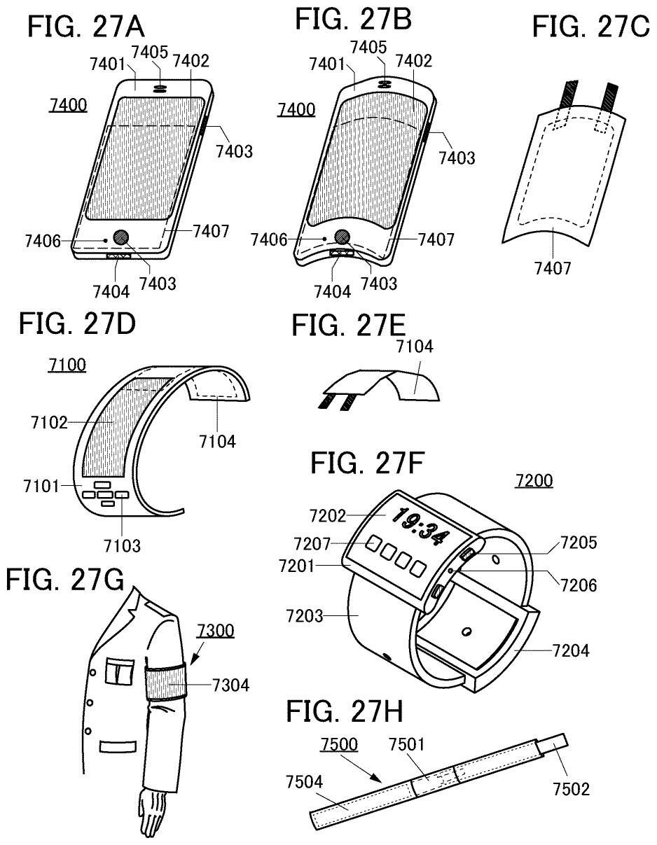

FIG. 27A illustrates an example of a mobile phone. A mobile phone 7400 is provided with a display portion 7402 incorporated in a housing 7401, operation buttons 7403, an external connection port 7404, a speaker 7405, a microphone 7406, and the like. Note that the mobile phone 7400 includes a secondary battery 7407. When the secondary battery of one embodiment of the present invention is used as the secondary battery 7407, a lightweight mobile phone with a long lifetime can be provided. To improve safety, a protection circuit that prevents overcharging and/or overdischarging of the secondary battery 7407 may be electrically connected to the secondary battery 7407.

FIG. 27B illustrates the state where the mobile phone 7400 is bent. When the whole mobile phone 7400 is curved by external force, the secondary battery 7407 provided therein is also curved. FIG. 27C illustrates the bent secondary battery 7407. The secondary battery 7407 is a thin storage battery. The secondary battery 7407 is fixed in a state of being bent. Note that the secondary battery 7407 includes a lead electrode electrically connected to a current collector. The current collector is, for example, copper foil, and partly alloyed with gallium; thus, adhesion between the current collector and an active material layer in contact with the current collector is improved and the secondary battery 7407 can have high reliability even in a state of being bent.

FIG. 27D illustrates an example of a bangle-type display device. A portable display device 7100 includes a housing 7101, a display portion 7102, operation buttons 7103, and a secondary battery 7104. To improve safety, a protection circuit that prevents overcharging and/or overdischarging of the secondary battery 7104 may be electrically connected to the secondary battery 7104. FIG. 27E illustrates the bent secondary battery 7104. When the display device is worn on a user's arm while the secondary battery 7104 is bent, the housing changes its shape and the curvature of part or the whole of the secondary battery 7104 is changed. Note that the bending condition of a curve at a given point that is represented by a value of the radius of a corresponding circle is referred to as the radius of curvature, and the reciprocal of the radius of curvature is referred to as curvature. Specifically, part or the whole of the housing or the main surface of the secondary battery 7104 is changed in the range of radius of curvature from 40 mm or more to 150 mm or less. When the radius of curvature at the main surface of the secondary battery 7104 is in the range from 40 mm or more to 150 mm or less, the reliability can be kept high. When the secondary battery of one embodiment of the present invention is used as the secondary battery 7104, a lightweight portable display device with a long lifetime can be provided.

FIG. 27F illustrates an example of a watch-type portable information terminal. A portable information terminal 7200 includes a housing 7201, a display portion 7202, a band 7203, a buckle 7204, an operation button 7205, an input/output terminal 7206, and the like.

The portable information terminal 7200 is capable of executing a variety of applications such as mobile phone calls, e-mailing, viewing and editing texts, music reproduction, Internet communication, and a computer game.

The display surface of the display portion 7202 is curved, and images can be displayed on the curved display surface. In addition, the display portion 7202 includes a touch sensor, and operation can be performed by touching the screen with a finger, a stylus, or the like. For example, by touching an icon 7207 displayed on the display portion 7202, application can be started.

With the operation button 7205, a variety of functions such as time setting, power on/off, on/off of wireless communication, setting and cancellation of a silent mode, and setting and cancellation of a power saving mode can be performed. For example, the functions of the operation button 7205 can be set freely by setting the operating system incorporated in the portable information terminal 7200.

The portable information terminal 7200 can perform near field communication that is standardized communication. For example, mutual communication between the portable information terminal 7200 and a headset capable of wireless communication enables hands-free calling.

The portable information terminal 7200 includes the input/output terminal 7206, and data can be directly transmitted to and received from another information terminal via a connector. In addition, charging via the input/output terminal 7206 is possible. Note that the charging operation may be performed by wireless power feeding without using the input/output terminal 7206.

The display portion 7202 of the portable information terminal 7200 includes the secondary battery of one embodiment of the present invention. When the secondary battery of one embodiment of the present invention is used, a lightweight portable information terminal with a long lifetime can be provided. To improve safety, a protection circuit that prevents overcharging and/or overdischarging of the secondary battery may be electrically connected to the secondary battery. For example, the secondary battery 7104 illustrated in FIG. 27E can be provided in the housing 7201 while being curved, or can be provided in the band 7203 such that it can be curved.

The portable information terminal 7200 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 27G illustrates an example of an armband display device. A display device 7300 includes a display portion 7304 and the secondary battery of one embodiment of the present invention. To improve safety, a protection circuit that prevents overcharging and/or overdischarging of the secondary battery may be electrically connected to the secondary battery. The display device 7300 can include a touch sensor in the display portion 7304 and can serve as a portable information terminal.

The display surface of the display portion 7304 is curved, and images can be displayed on the curved display surface. A display state of the display device 7300 can be changed by, for example, near field communication that is standardized communication.

The display device 7300 includes an input/output terminal, and data can be directly transmitted to and received from another information terminal via a connector. In addition, charging via the input/output terminal is possible. Note that the charging operation may be performed by wireless power feeding without using the input/output terminal.

When the secondary battery of one embodiment of the present invention is used as the secondary battery included in the display device 7300, a lightweight display device with a long lifetime can be provided.

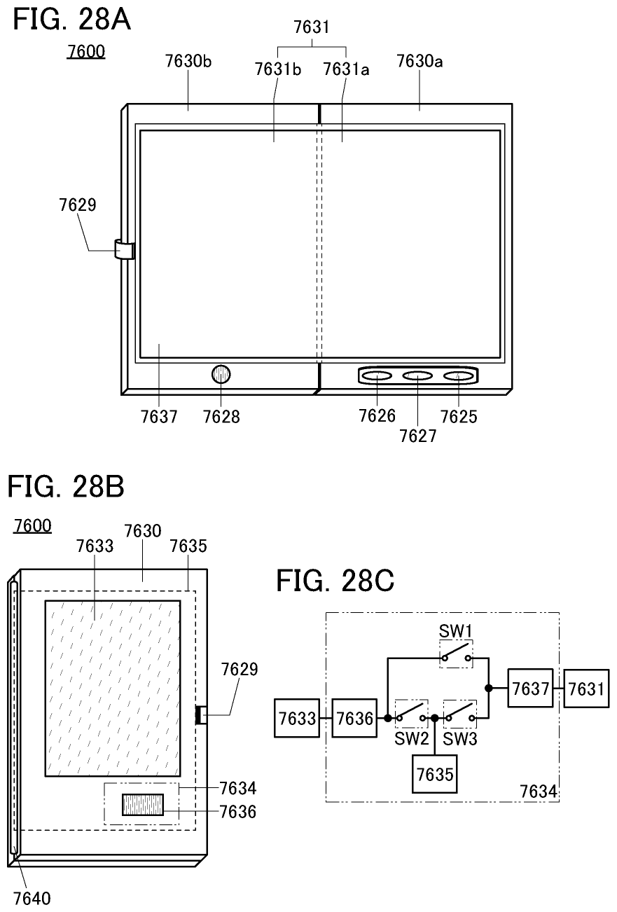

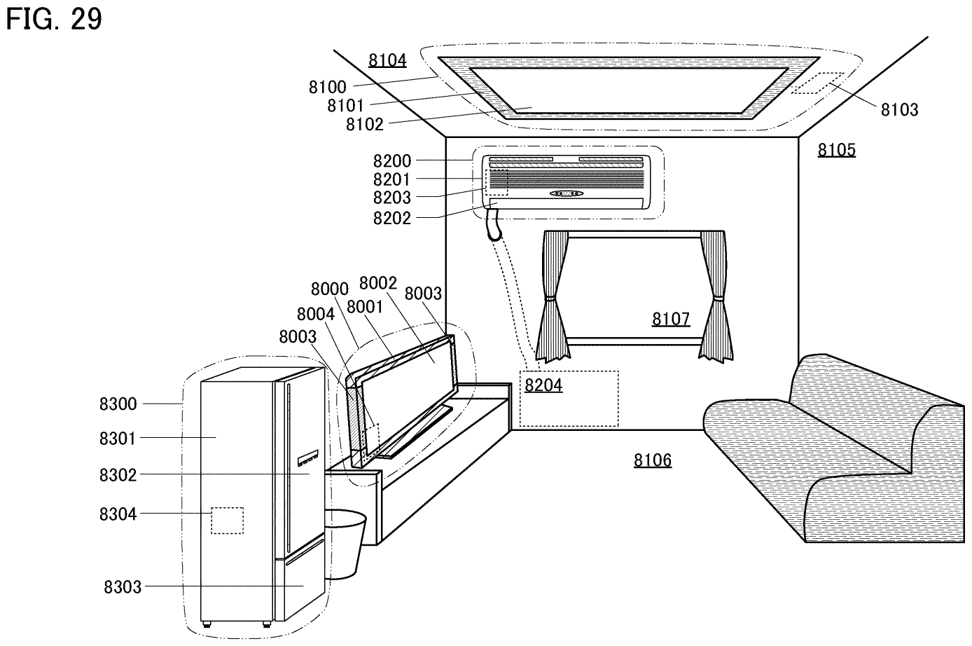

In addition, examples of electronic devices each including the secondary battery with excellent cycle performance of one embodiment of the present invention are described with reference to FIG. 27H, FIG. 28, and FIG. 29.

When the secondary battery of one embodiment of the present invention is used as a secondary battery of an electronic device, a lightweight product with a long lifetime can be provided. Examples of the daily electronic device include an electric toothbrush, an electric shaver, and electric beauty equipment. As secondary batteries of these products, small and lightweight stick type secondary batteries with high capacity are desired in consideration of handling ease for users.

FIG. 27H is a perspective view of a device called a cigarette smoking device (electronic cigarette). In FIG. 27H, an electronic cigarette 7500 includes an atomizer 7501 including a heating element, a secondary battery 7504 that supplies electric power to the atomizer, and a cartridge 7502 including a liquid supply bottle, a sensor, or the like. To improve safety, a protection circuit that prevents overcharging and/or overdischarging of the secondary battery 7504 may be electrically connected to the secondary battery 7504. The secondary battery 7504 illustrated in FIG. 27H includes an external terminal for connection to a charger. When the electronic cigarette 7500 is held, the secondary battery 7504 is a tip portion; thus, it is preferred that the secondary battery 7504 have a short total length and be lightweight. With the secondary battery of one embodiment of the present invention, which has high capacity and excellent cycle performance, the small and lightweight electronic cigarette 7500 that can be used for a long time over a long period can be provided.

Next, FIG. 28A and FIG. 28B illustrate an example of a tablet terminal that can be folded in half. A tablet terminal 7600 illustrated in FIG. 28A and FIG. 28B include a housing 7630a, a housing 7630b, a movable portion 7640 connecting the housing 7630a and the housing 7630b to each other, a display portion 7631 including a display portion 7631a and a display portion 7631b, a switch 7625 to a switch 7627, a fastener 7629, and an operation switch 7628. A flexible panel is used for the display portion 7631, whereby a tablet terminal with a larger display portion can be provided. FIG. 28A illustrates the tablet terminal 7600 that is opened, and FIG. 28B illustrates the tablet terminal 7600 that is closed.

The tablet terminal 7600 includes a power storage unit 7635 inside the housing 7630a and the housing 7630b. The power storage unit 7635 is provided across the housing 7630a and the housing 7630b, passing through the movable portion 7640.

The entire region or part of the region of the display portion 7631 can be a touch panel region, and data can be input by touching text, an input form, an image including an icon, and the like displayed on the region. For example, it is possible that keyboard buttons are displayed on the entire display portion 7631a on the housing 7630a side, and data such as text or an image is displayed on the display portion 7631b on the housing 7630b side.

It is possible that a keyboard is displayed on the display portion 7631b on the housing 7630b side, and data such as text or an image is displayed on the display portion 7631a on the housing 7630a side. Furthermore, it is possible that a switching button for showing/hiding a keyboard on a touch panel is displayed on the display portion 7631 and the button is touched with a finger, a stylus, or the like to display a keyboard on the display portion 7631.

Touch input can be performed concurrently in a touch panel region in the display portion 7631a on the housing 7630a side and a touch panel region in the display portion 7631b on the housing 7630b side.

The switch 7625 to the switch 7627 may function not only as an interface for operating the tablet terminal 7600 but also as an interface that can switch various functions. For example, at least one of the switch 7625 to the switch 7627 may function as a switch for switching power on/off of the tablet terminal 7600. For another example, at least one of the switch 7625 to the switch 7627 may have a function of switching the display orientation between a portrait mode and a landscape mode or a function of switching display between monochrome display and color display. For another example, at least one of the switch 7625 to the switch 7627 may have a function of adjusting the luminance of the display portion 7631. The luminance of the display portion 7631 can be optimized in accordance with the amount of external light in use of the tablet terminal 7600 detected by an optical sensor incorporated in the tablet terminal 7600. Note that another sensing device including a sensor for measuring inclination, such as a gyroscope sensor or an acceleration sensor, may be incorporated in the tablet terminal, in addition to the optical sensor.

FIG. 28A illustrates an example in which the display portion 7631a on the housing 7630a side and the display portion 7631b on the housing 7630b side have substantially the same display area; however, there is no particular limitation on the display areas of the display portion 7631a and the display portion 7631b, and the display portions may have different sizes or different display quality. For example, one may be a display panel that can display higher-definition images than the other.

The tablet terminal 7600 is folded in half in FIG. 28B. The tablet terminal 7600 includes a housing 7630, a solar cell 7633, and a charging-discharging control circuit 7634 including a DCDC converter 7636. The secondary battery of one embodiment of the present invention is used as the power storage unit 7635.

Note that as described above, the tablet terminal 7600 can be folded in half, and thus can be folded when not in use such that the housing 7630a and the housing 7630b overlap with each other. By the folding, the display portion 7631 can be protected, which increases the durability of the tablet terminal 7600. With the power storage unit 7635 including the secondary battery of one embodiment of the present invention, which has high capacity and excellent cycle performance, the tablet terminal 7600 that can be used for a long time over a long period can be provided. To improve safety, a protection circuit that prevents overcharging and/or overdischarging of the secondary battery included in the power storage unit 7635 may be electrically connected to the secondary battery.

The tablet terminal 7600 illustrated in FIG. 28A and FIG. 28B can also have a function of displaying various kinds of data (e.g., a still image, a moving image, and a text image), a function of displaying a calendar, a date, or the time on the display portion, a touch-input function of operating or editing data displayed on the display portion by touch input, a function of controlling processing by various kinds of software (programs), and the like.

The solar cell 7633, which is attached on the surface of the tablet terminal 7600, can supply electric power to a touch panel, a display portion, a video signal processing portion, and the like. Note that the solar cell 7633 can be provided on one surface or both surfaces of the housing 7630 and the power storage unit 7635 can be charged efficiently. The use of a lithium-ion battery as the power storage unit 7635 brings an advantage such as a reduction in size.

The structure and operation of the charging-discharging control circuit 7634 illustrated in FIG. 28B are described with reference to a block diagram in FIG. 28C. The solar cell 7633, the power storage unit 7635, the DCDC converter 7636, a converter 7637, a switch SW1 to a switch SW3, and the display portion 7631 are illustrated in FIG. 28C, and the power storage unit 7635, the DCDC converter 7636, the converter 7637, and the switch SW1 to the switch SW3 correspond to the charging-discharging control circuit 7634 illustrated in FIG. 28B.

First, an operation example in which electric power is generated by the solar cell 7633 using external light is described. The voltage of electric power generated by the solar cell is raised or lowered by the DCDC converter 7636 to a voltage for charging the power storage unit 7635. When the display portion 7631 is operated with the electric power from the solar cell 7633, the switch SW1 is turned on and the voltage is raised or lowered by the converter 7637 to a voltage needed for the display portion 7631. When display on the display portion 7631 is not performed, the switch SW1 is turned off and the switch SW2 is turned on, so that the power storage unit 7635 can be charged.

Note that the solar cell 7633 is described as an example of a power generation unit; however, one embodiment of the present invention is not limited to this example. The power storage unit 7635 may be charged using another power generation unit such as a piezoelectric element or a thermoelectric conversion element (Peltier element). For example, the charging may be performed with a non-contact power transmission module that performs charging by transmitting and receiving electric power wirelessly (without contact), or with a combination of other charging units.

FIG. 29 illustrates other examples of electronic devices. In FIG. 29, a display device 8000 is an example of an electronic device including a secondary battery 8004 of one embodiment of the present invention. Specifically, the display device 8000 corresponds to a display device for TV broadcast reception and includes a housing 8001, a display portion 8002, speaker portions 8003, the secondary battery 8004, and the like. To improve safety, a protection circuit that prevents overcharging and/or overdischarging of the secondary battery 8004 may be electrically connected to the secondary battery 8004. The secondary battery 8004 of one embodiment of the present invention is provided in the housing 8001. The display device 8000 can be supplied with electric power from a commercial power supply and can use electric power stored in the secondary battery 8004. Thus, the display device 8000 can be operated with the use of the secondary battery 8004 of one embodiment of the present invention as an uninterruptible power supply even when electric power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a DMD (Digital Micromirror Device), a PDP (Plasma Display Panel), or an FED (Field Emission Display) can be used for the display portion 8002.

Note that the display device includes all of information display devices for personal computers, advertisement displays, and the like besides information display devices for TV broadcast reception.

In FIG. 29, an installation lighting device 8100 is an example of an electronic device including a secondary battery 8103 of one embodiment of the present invention. Specifically, the lighting device 8100 includes a housing 8101, a light source 8102, the secondary battery 8103, and the like. To improve safety, a protection circuit that prevents overcharging and/or overdischarging of the secondary battery 8103 may be electrically connected to the secondary battery 8103. Although FIG. 29 illustrates the case where the secondary battery 8103 is provided in a ceiling 8104 on which the housing 8101 and the light source 8102 are installed, the secondary battery 8103 may be provided in the housing 8101. The lighting device 8100 can be supplied with electric power from a commercial power supply and can use electric power stored in the secondary battery 8103. Thus, the lighting device 8100 can be operated with the use of the secondary battery 8103 of one embodiment of the present invention as an uninterruptible power supply even when electric power cannot be supplied from a commercial power supply due to power failure or the like.

Note that although the installation lighting device 8100 provided in the ceiling 8104 is illustrated in FIG. 29 as an example, the secondary battery of one embodiment of the present invention can be used in an installation lighting device provided in, for example, a side wall 8105, a floor 8106, or a window 8107 other than the ceiling 8104, and can be used in a tabletop lighting device or the like.

As the light source 8102, an artificial light source that emits light artificially by using electric power can be used. Specifically, an incandescent lamp, a discharge lamp such as a fluorescent lamp, and light-emitting elements such as an LED and/or an organic EL element are given as examples of the artificial light source.

In FIG. 29, an air conditioner including an indoor unit 8200 and an outdoor unit 8204 is an example of an electronic device including a secondary battery 8203 of one embodiment of the present invention. Specifically, the indoor unit 8200 includes a housing 8201, an air outlet 8202, the secondary battery 8203, and the like. To improve safety, a protection circuit that prevents overcharging and/or overdischarging of the secondary battery 8203 may be electrically connected to the secondary battery 8203. Although FIG. 29 illustrates the case where the secondary battery 8203 is provided in the indoor unit 8200, the secondary battery 8203 may be provided in the outdoor unit 8204. Alternatively, the secondary batteries 8203 may be provided in both the indoor unit 8200 and the outdoor unit 8204. The air conditioner can be supplied with electric power from a commercial power supply and can use electric power stored in the secondary battery 8203. Particularly in the case where the secondary batteries 8203 are provided in both the indoor unit 8200 and the outdoor unit 8204, the air conditioner can be operated with the use of the secondary battery 8203 of one embodiment of the present invention as an uninterruptible power supply even when electric power cannot be supplied from a commercial power supply due to power failure or the like.

Note that although the split-type air conditioner including the indoor unit and the outdoor unit is illustrated in FIG. 29 as an example, the secondary battery of one embodiment of the present invention can be used in an air conditioner in which the functions of an indoor unit and an outdoor unit are integrated in one housing.

In FIG. 29, an electric refrigerator-freezer 8300 is an example of an electronic device including a secondary battery 8304 of one embodiment of the present invention. Specifically, the electric refrigerator-freezer 8300 includes a housing 8301, a refrigerator door 8302, a freezer door 8303, the secondary battery 8304, and the like. To improve safety, a protection circuit that prevents overcharging and/or overdischarging of the secondary battery 8304 may be electrically connected to the secondary battery 8304. The secondary battery 8304 is provided in the housing 8301 in FIG. 29. The electric refrigerator-freezer 8300 can be supplied with electric power from a commercial power supply and can use electric power stored in the secondary battery 8304. Thus, the electric refrigerator-freezer 8300 can be operated with the use of the secondary battery 8304 of one embodiment of the present invention as an uninterruptible power supply even when electric power cannot be supplied from a commercial power supply due to power failure or the like.

Note that among the electronic devices described above, a high-frequency heating apparatus such as a microwave oven and an electronic device such as an electric rice cooker require high electric power in a short time. Accordingly, the tripping of a breaker of a commercial power supply in use of the electronic device can be prevented by using the secondary battery of one embodiment of the present invention as an auxiliary power supply for supplying electric power that cannot be supplied enough by a commercial power supply.

In a time period when electronic devices are not used, particularly when the proportion of the amount of electric power that is actually used to the total amount of electric power that can be supplied from a commercial power supply (such a proportion is referred to as a usage rate of electric power) is low, electric power is stored in the secondary battery, whereby an increase in the usage rate of electric power can be inhibited in a time period other than the above time period. For example, in the case of the electric refrigerator-freezer 8300, electric power is stored in the secondary battery 8304 in night time when the ambient temperature is low and the refrigerator door 8302 and the freezer door 8303 are not opened or closed. Moreover, in daytime when the ambient temperature rises and the refrigerator door 8302 and the freezer door 8303 are opened and closed, the usage rate of electric power in daytime can be kept low by using the secondary battery 8304 as an auxiliary power supply.

According to one embodiment of the present invention, the secondary battery can have excellent cycle performance and improved reliability. Furthermore, according to one embodiment of the present invention, a secondary battery with high capacity can be obtained; thus, the secondary battery itself can be made more compact and lightweight as a result of improved characteristics of the secondary battery. Thus, the secondary battery of one embodiment of the present invention is used in the electronic device described in this embodiment, whereby a more lightweight electronic device with a longer lifetime can be obtained.

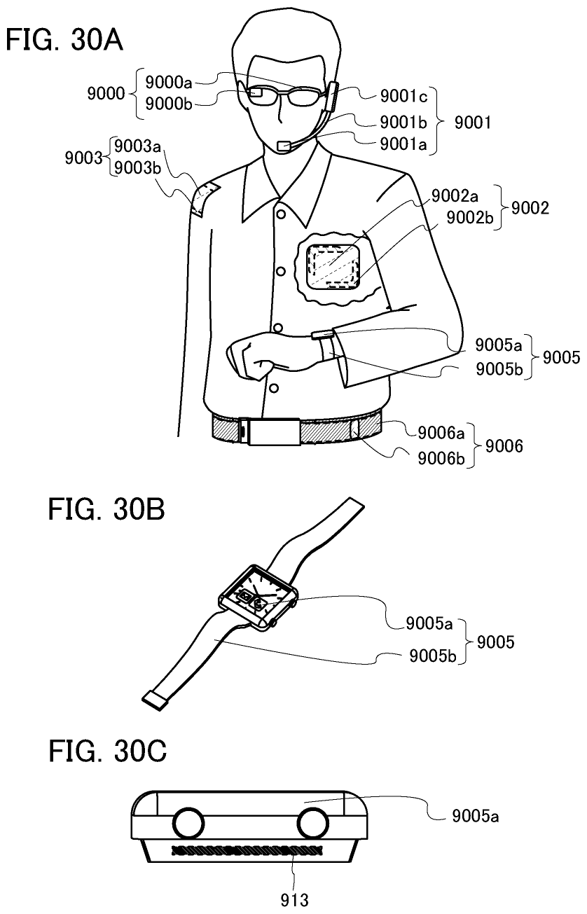

FIG. 30A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

For example, the secondary battery of one embodiment of the present invention can be provided in a glasses-type device 9000 illustrated in FIG. 30A. The glasses-type device 9000 includes a frame 9000a and a display portion 9000b. The secondary battery is provided in a temple portion of the frame 9000a having a curved shape, whereby the glasses-type device 9000 can be lightweight, can have a well-balanced weight, and can be used continuously for a long time. To improve safety, a protection circuit that prevents overcharging and/or overdischarging of the secondary battery may be electrically connected to the secondary battery. With the use of the secondary battery of one embodiment of the present invention, space saving required with downsizing of a housing can be achieved.

The secondary battery of one embodiment of the present invention can be provided in a headset-type device 9001. The headset-type device 9001 includes at least a microphone portion 9001a, a flexible pipe 9001b, and an earphone portion 9001c. The secondary battery can be provided in the flexible pipe 9001b or the earphone portion 9001c. To improve safety, a protection circuit that prevents overcharging and/or overdischarging of the secondary battery may be electrically connected to the secondary battery. With the use of the secondary battery of one embodiment of the present invention, space saving required with downsizing of a housing can be achieved.

The secondary battery of one embodiment of the present invention can be provided in a device 9002 that can be attached directly to a body. A secondary battery 9002b can be provided in a thin housing 9002a of the device 9002. To improve safety, a protection circuit that prevents overcharging and/or overdischarging of the secondary battery 9002b may be electrically connected to the secondary battery 9002b. With the use of the secondary battery of one embodiment of the present invention, space saving required with downsizing of a housing can be achieved.

The secondary battery of one embodiment of the present invention can be provided in a device 9003 that can be attached to clothes. A secondary battery 9003b can be provided in a thin housing 9003a of the device 9003. To improve safety, a protection circuit that prevents overcharging and/or overdischarging of the secondary battery 9003b may be electrically connected to the secondary battery 9003b. With the use of the secondary battery of one embodiment of the present invention, space saving required with downsizing of a housing can be achieved.

The secondary battery of one embodiment of the present invention can be provided in a belt-type device 9006. The belt-type device 9006 includes a belt portion 9006a and a wireless power feeding and receiving portion 9006b, and the secondary battery can be provided inside the belt portion 9006a. To improve safety, a protection circuit that prevents overcharging and/or overdischarging of the secondary battery may be electrically connected to the secondary battery. With the use of the secondary battery of one embodiment of the present invention, space saving required with downsizing of a housing can be achieved.

The secondary battery of one embodiment of the present invention can be provided in a watch-type device 9005. The watch-type device 9005 includes a display portion 9005a and a belt portion 9005b, and the secondary battery can be provided in the display portion 9005a or the belt portion 9005b. To improve safety, a protection circuit that prevents overcharging and/or overdischarging of the secondary battery may be electrically connected to the secondary battery. With the use of the secondary battery of one embodiment of the present invention, space saving required with downsizing of a housing can be achieved.

The display portion 9005a can display various kinds of information such as time and reception information of an e-mail and/or an incoming call.

The watch-type device 9005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 30B illustrates a perspective view of the watch-type device 9005 that is detached from an arm.

FIG. 30C illustrates a side view. FIG. 30C illustrates a state where the secondary battery 913 of one embodiment of the present invention is incorporated in the watch-type device 9005. The secondary battery 913 is provided to overlap with the display portion 9005a and is small and lightweight.

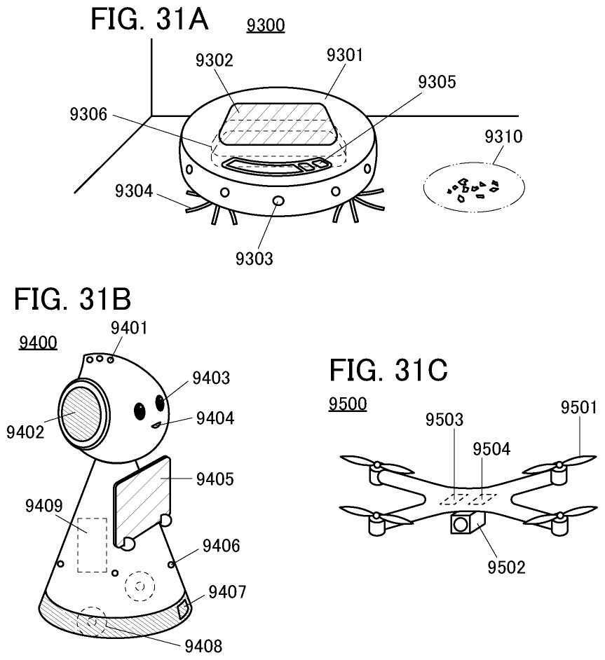

FIG. 31A illustrates an example of a cleaning robot. A cleaning robot 9300 includes a display portion 9302 placed on the top surface of a housing 9301, a plurality of cameras 9303 placed on the side surface of the housing 9301, a brush 9304, operation buttons 9305, a secondary battery 9306, a variety of sensors, and the like. To improve safety, a protection circuit that prevents overcharging and/or overdischarging of the secondary battery 9306 may be electrically connected to the secondary battery 9306. Although not illustrated, the cleaning robot 9300 is provided with a tire, an inlet, and the like. The cleaning robot 9300 is self-propelled, detects dust 9310, and sucks up the dust through the inlet provided on the bottom surface.

For example, the cleaning robot 9300 can determine whether there is an obstacle such as a wall, furniture, or a step by analyzing images taken by the cameras 9303. In the case where the cleaning robot 9300 detects an object, such as a wire, that is likely to be caught in the brush 9304 by image analysis, the rotation of the brush 9304 can be stopped. The cleaning robot 9300 includes a secondary battery 9306 of one embodiment of the present invention and a semiconductor device or an electronic component. The cleaning robot 9300 including the secondary battery 9306 of one embodiment of the present invention can be a highly reliable electronic device that can operate for a long time.

FIG. 31B illustrates an example of a robot. A robot 9400 illustrated in FIG. 31B includes a secondary battery 9409, an illuminance sensor 9401, a microphone 9402, an upper camera 9403, a speaker 9404, a display portion 9405, a lower camera 9406, an obstacle sensor 9407, a moving mechanism 9408, an arithmetic device, and the like. To improve safety, a protection circuit that prevents overcharging and/or overdischarging of the secondary battery 9409 may be electrically connected to the secondary battery 9409.

The microphone 9402 has a function of detecting a speaking voice of a user, an environmental sound, and the like. The speaker 9404 has a function of outputting sound. The robot 9400 can communicate with the user using the microphone 9402 and the speaker 9404.

The display portion 9405 has a function of displaying various kinds of information. The robot 9400 can display information desired by the user on the display portion 9405. The display portion 9405 may be provided with a touch panel. Moreover, the display portion 9405 may be a detachable information terminal, in which case charging and data communication can be performed when the display portion 9405 is set at the home position of the robot 9400.

The upper camera 9403 and the lower camera 9406 each have a function of taking an image of the surroundings of the robot 9400. The obstacle sensor 9407 can detect, with the use of the moving mechanism 9408, the presence of an obstacle in the direction where the robot 9400 advances. The robot 9400 can move safely by recognizing the surroundings with the upper camera 9403, the lower camera 9406, and the obstacle sensor 9407.

The robot 9400 includes the secondary battery 9409 of one embodiment of the present invention and a semiconductor device or an electronic component. The robot 9400 including the secondary battery of one embodiment of the present invention can be a highly reliable electronic device that can operate for a long time.

FIG. 31C illustrates an example of a flying object. A flying object 9500 illustrated in FIG. 31C includes propellers 9501, a camera 9502, a secondary battery 9503, and the like and has a function of flying autonomously. To improve safety, a protection circuit that prevents overcharging and/or overdischarging of the secondary battery 9503 may be electrically connected to the secondary battery 9503.

For example, image data taken by the camera 9502 is stored in an electronic component 9504. The electronic component 9504 can analyze the image data to detect whether there is an obstacle in the way of the movement. Moreover, the electronic component 9504 can estimate the remaining battery level from a change in the power storage capacity of the secondary battery 9503. The flying object 9500 includes the secondary battery 9503 of one embodiment of the present invention. The flying object 9500 including the secondary battery of one embodiment of the present invention can be a highly reliable electronic device that can operate for a long time.

This embodiment can be implemented in appropriate combination with any of the other embodiments.

### Example 1

In this example, a ceramic-based powdery material was stirred in a cobalt solution and the concentration of the cobalt solution was measured in order to confirm whether the ceramic-based material traps cobalt ions.

First, in order to mix an organic solvent, Li-TFSI was added at a concentration of 1 mol/L with respect to EC:DEC=3:7 (volume ratio) (Kishida Chemical Co., Ltd.) in a glove box with an argon atmosphere, and stirring was performed at room temperature for approximately 18 hours.

Next, a sample cell in which a Li metal is immersed in an organic solvent and a sample cell in which a cobalt foil is immersed in an organic solvent were prepared in the glove box with an argon atmosphere. The two cells were connected and a glass filter was provided between the cells. As the glass filter, lithium ion conductive glass ceramics (LICGC) produced by Ohara Inc. was used. The glass filter was provided for preventing a product generated by electrolysis from being reduced at a counter electrode side. Between the Li metal and the cobalt foil, DC 3.6 V was applied for 20 hours, and approximately 15 mL of cobalt solution with approximately 50 ppm was formed.

Next, a cobalt solution was added to each of the ceramic-based materials and stirred. Specifically, a stirring means was put into each of six 5-ml-sample bottles, and then approximately 30 mg of magnesium oxide (MgO), magnesium hydroxide (Mg(OH)₂), alumina (Al₂O₃), Boehmite (AlOOH), rutile-type titanium oxide (TiO₂), and anatase-type titanium oxide were respectively put into the sample bottles. These sample bottles were put into the glove box; then, 2 ml of cobalt solution was added to each of the sample bottles, and stirring was performed at room temperature at 300 rpm for approximately 16 hours.

After the stirring, the sample bottles were taken out from the glove box. The stirred suspension was filtered using a membrane filter so as to be separated into a cobalt solution, which is a filtrate, and a ceramic-based material, which is a residue.

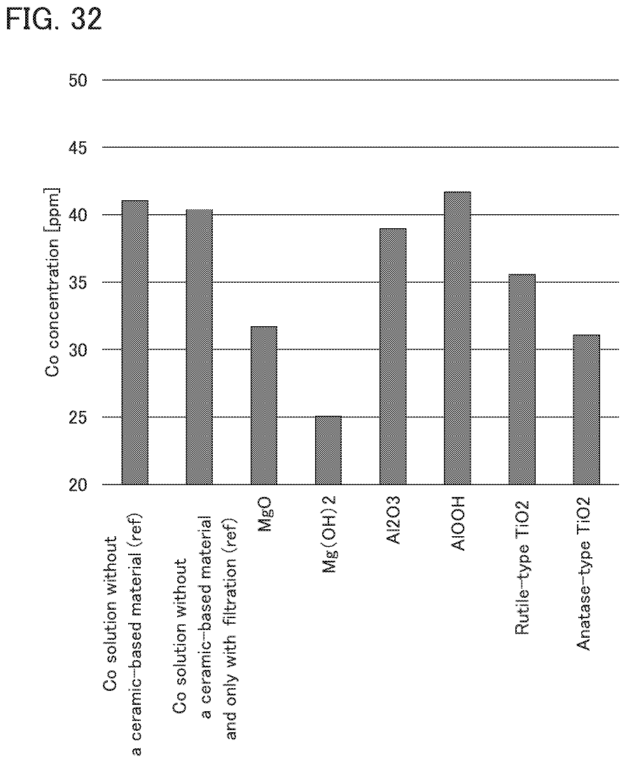

The cobalt concentration in the cobalt solution, which was separated from each of the ceramic-based materials, was measured by an atomic absorption spectrometer (Analytik Jena Co., Ltd. ContrAA 600). The measurement was performed twice per cobalt solution, which was separated from each of the ceramic-based materials, and the average value of them was calculated. FIG. 32 shows the measurement results.

The obtained cobalt concentration in the MgO sample was 32.55 ppm and 30.82 ppm in a first time and a second time, respectively, the average value of which was 31.69 ppm. The obtained cobalt concentration in the Mg(OH)₂ sample was 23.40 ppm and 26.72 ppm in a first time and a second time, respectively, the average value of which was 25.06 ppm. The obtained cobalt concentration in the Al₂O₃ sample was 37.63 ppm and 40.27 ppm in a first time and a second time, respectively, the average value of which was 38.95 ppm. The obtained cobalt concentration in the AlOOH sample was 40.20 ppm and 43.18 ppm in a first time and a second time, respectively, the average value of which was 41.69 ppm. The obtained cobalt concentration in the rutile-type TiO₂ sample was 36.56 ppm and 34.59 ppm in a first time and a second time, respectively, the average value of which was 35.58 ppm. The obtained cobalt concentration in the anatase-type TiO₂ sample was 31.05 ppm and 31.07 ppm in a first time and a second time, respectively, the average value of which was 31.06 ppm. As a comparative example, in a cobalt solution to which a ceramic-based material is not added, the obtained cobalt concentration was 40.65 ppm and 41.40 ppm in a first time and a second time, respectively, the average value of which was 41.03 ppm. In a sample obtained by filtering a cobalt solution to which a ceramic-based material is not added, the cobalt concentration was 42.97 ppm and 42.40 ppm in a first time and a second time, respectively, the average value of which was 42.69 ppm.

From the above-described measurement results, it was found that the cobalt concentration of the Mg(OH)₂ sample after filtration was low. This suggests that Mg(OH)₂ probably traps cobalt ions.

### Example 2

In this example, a polypropylene separator coated with an MgO layer was manufactured. The manufacturing method is as follows.

First, 2 g of MgO and 0.96296 g of NMP were mixed at 2000 rpm for 3 minutes by a mixer (a planetary centrifugal mixer Awatorirentaro manufactured by THINKY CORPORATION). MgO and NMP were mixed first, and then MgO was dispersed. To the obtained mixture, 0.2 g of NMP solution containing 5 wt % of PVdF was added, and mixed by the mixer. After that, 4.24444 g of the NMP solution containing 5 wt % of PVdF was added to the obtained mixture, and mixed by the mixer. PVdF was added little by little for preventing cohesion of PVdF. Through the above steps, slurry, which has a proportion of the solid content of 30% (MgO:PVdF=90:10), was formed.

Next, slurry was applied onto a 20-μm-thick polypropylene separator with the use of an applicator. At this time, the distance between an applicator member of the applicator (blade) and a surface where the slurry was applied (a surface of the polypropylene separator) was 40 μm and the application rate was 10 mm/sec.

The polypropylene separator coated with the slurry was dried in a circulation drying oven at 80° C. for 30 minutes.

In the polypropylene separator coated with the MgO layer obtained by the above-described steps, the thickness of the MgO layer was measured using a micrometer. The thickness of the separator coated with the MgO layer was 45 μm to 60 μm, and the thickness of the polypropylene separator was 20 μm. Accordingly, the thickness of the MgO layer was approximately 25 μm to 40 μm.

### Example 3

In this example, a polypropylene separator coated with an Mg(OH) 2 layer was manufactured. The manufacturing method is as follows.

First, 2 g of Mg(OH) 2 and 2 g of NMP were mixed at 2000 rpm for 3 minutes by a mixer (a planetary centrifugal mixer Awatorirentaro manufactured by THINKY CORPORATION). The average grain diameter of Mg(OH)₂ particles that were used was approximately 7 μm. For measuring the average grain diameter of Mg(OH)₂ particles, a laser diffraction particle size distribution measurement tool (manufactured by Shimadzu Corporation, SALD-2200) was used. Mg(OH)₂ and NMP were mixed first, and then Mg(OH)₂ was dispersed. To the obtained mixture, 0.2 g of NMP solution containing 5 wt % of PVdF was added, and mixed by the mixer. After that, 4.24444 g of the NMP solution containing 5 wt % of PVdF was added to the obtained mixture and mixed by the mixer. PVdF was added little by little for preventing cohesion of PVdF. Through the above steps, slurry, which has a proportion of the solid content of 26% (Mg(OH)₂:PVdF=90:10), was formed.

Next, slurry was applied onto a 20-μm-thick polypropylene separator with the use of an applicator. At this time, the distance between an applicator member of the applicator (blade) and a surface where the slurry was applied (a surface of the polypropylene separator) was 30 μm and the application rate was 10 mm/sec.

The polypropylene separator coated with the slurry was dried in a circulation drying oven at 80° C. for 30 minutes.

In the separator coated with the Mg(OH)₂ layer obtained by the above-described steps, the thickness of the Mg(OH)₂ layer was measured using a micrometer. The thickness of the separator coated with the Mg(OH)₂ layer was 70 μm to 80 μm, and the thickness of the polypropylene separator was 20 μm. Accordingly, the thickness of the Mg(OH)₂ layer was approximately 50 μm to 60 μm.

The density of the Mg(OH)₂ layer was obtained as follows. First, each of the polypropylene separator coated with the Mg(OH)₂ layer and a polypropylene separator that is not coated with the Mg(OH)₂ layer were stamped into a circular shape with a diameter of 18 mm, and then the weight and the thickness of them were measured. Consequently, the weight and the thickness of the polypropylene separator coated with the Mg(OH)₂ layer were 9.271 mg and 75 μm, respectively, and the weight and the thickness of the polypropylene separator alone were 3.536 mg and 20 μm, respectively. Thus, the weight and the thickness of the Mg(OH)₂ layer were 5.735 mg and 55 μm, respectively. The calculated weight and thickness of the Mg(OH)₂ layer and the area of the circle with a diameter of 18 mm, 2.5434 cm², were substituted into the formula: density=weight÷thickness÷area; thus, the density of the Mg(OH)₂ layer was calculated to be approximately 410 mg/cm³.

The porosity of the Mg(OH)₂ layer is a value obtained by the following manner: the density of the Mg(OH)₂ layer is divided by the density of the Mg(OH)₂ layer with the porosity of 0, and the value is subtracted from 1. The density of the Mg(OH)₂ layer with the porosity of 0 is 2300 mg/cm³ since the density of Mg(OH)₂ material and the density of PVdF material are 2360 mg/cm³ and 1780 mg/cm³, respectively. Thus, the porosity of the Mg(OH)₂ layer was approximately 82.2 volume %.

### REFERENCE NUMERALS

102: space in heating furnace, 104: hot plate, 106: heater unit, 108: heat insulator, 116: container, 118: lid, 119: space, 120: heating furnace, 130: stack, 131: stack, 500: secondary battery, 501: positive electrode current collector, 502a: region, 502: positive electrode active material layer, 503: positive electrode, 504: negative electrode current collector, 505a: region, 505: negative electrode active material layer, 506: negative electrode, 507a: region, 507b: region, 507: separator, 508: electrolyte, 509a: exterior body, 509b: exterior body, 509: exterior body, 510: positive electrode lead electrode, 511: negative electrode lead electrode, 512: stack, 513: resin layer, 514: region, 515a: electrolyte, 515b: electrolyte, 515c: electrolyte, 516: inlet, 521a: region, 521b: region, 521: polymer porous film, 522: layer, 550: stack, 553: acetylene black, 554: graphene, 556: acetylene black, 557: graphene, 560: secondary battery, 561: positive electrode active material, 563: negative electrode active material, 570: manufacturing apparatus, 571: component introduction chamber, 572: transfer chamber, 573: processing chamber, 576: component extraction chamber, 580: transfer mechanism, 581: polymer film, 582: hole, 584: polymer film, 585: hole, 591: stage, 594: nozzle, 600: secondary battery, 701: commercial power source, 703: distribution board, 705: power storage controller, 706: indicator, 707: general load, 708: power storage load, 709: router, 710: service wire mounting portion, 711: measuring portion, 712: predicting portion, 713: planning portion, 790: control device, 791: power storage device, 796: underfloor space, 799: building, 801: composite oxide, 802: fluoride, 803: compound, 804: mixture, 808: cobalt-containing material, 911a: terminal, 911b: terminal, 913: secondary battery, 930a: housing, 930b: housing, 930: housing, 931a: negative electrode active material layer, 931: negative electrode, 932a: positive electrode active material layer, 932: positive electrode, 933: separator, 950a: wound body, 950: wound body, 951: terminal, 952: terminal, 970: secondary battery, 971: housing, 972: stack, 973a: positive electrode lead electrode, 973b: terminal, 973c: conductor, 974a: negative electrode lead electrode, 974b: terminal, 974c: conductor, 975a: positive electrode, 975b: positive electrode, 976: separator, 977a: negative electrode, 1301a: first battery, 1301b: first battery, 1302: battery controller, 1303: motor controller, 1304: motor, 1305: gear, 1306: DCDC circuit, 1307: electric power steering, 1308: heater, 1309: defogger, 1310: DCDC circuit, 1311: second battery, 1312: inverter, 1313: audio, 1314: power window, 1315: lamp, 1316: tire, 1317: rear motor, 1320: control circuit portion, 1321: control circuit portion, 1322: control circuit, 1324: switch portion, 1325: external terminal, 1326: external terminal, 1415: battery pack, 1421: wiring, 1422: wiring, 2001: automobile, 2002: transporter, 2003: transport vehicle, 2004: aircraft, 2005: transport vehicle, 2100: electric bicycle, 2101: secondary battery, 2102: power storage device, 2103: display portion, 2104: control circuit, 2201: battery pack, 2202: battery pack, 2203: battery pack, 2204: battery pack, 2300: motor scooter, 2301: side mirror, 2302: power storage device, 2303: indicator light, 2304: under-seat storage unit, 2603: vehicle, 2604: charging device, 2610: solar panel, 2611: wiring, 2612: power storage device, 2800: personal computer, 2801: housing, 2802: housing, 2803: display portion, 2804: keyboard, 2805: pointing device, 2806: secondary battery, 2807: secondary battery, 7100: portable display device, 7101: housing, 7102: display portion, 7103: operation button, 7104: secondary battery, 7200: portable information terminal, 7201: housing, 7202: display portion, 7203: band, 7204: buckle, 7205: operation button, 7206: input/output terminal, 7207: icon, 7300: display device, 7304: display portion, 7400: mobile phone, 7401: housing, 7402: display portion, 7403: operation button, 7404: external connection port, 7405: speaker, 7406: microphone, 7407: secondary battery, 7500: electronic cigarette, 7501: atomizer, 7502: cartridge, 7504: secondary battery, 7600: tablet terminal, 7625: switch, 7627: switch, 7628: operation switch, 7629: fastener, 7630a: housing, 7630b: housing, 7630: housing, 7631a: display portion, 7631b: display portion, 7631: display portion, 7633: solar cell, 7634: charging-discharging control circuit, 7635: power storage unit, 7636: DCDC converter, 7637: converter, 7640: movable portion, 8000: display device, 8001: housing, 8002: display portion, 8003: speaker portion, 8004: secondary battery, 8100: lighting device, 8101: housing, 8102: light source, 8103: secondary battery, 8104: ceiling, 8105: side wall, 8106: floor, 8107: window, 8200: indoor unit, 8201: housing, 8202: air outlet, 8203: secondary battery, 8204: outdoor unit, 8300: electric refrigerator-freezer, 8301: housing, 8302: refrigerator door, 8303: freezer door, 8304: secondary battery, 9000a: frame, 9000b: display portion, 9000: glasses-type device, 9001a: microphone portion, 9001b: flexible pipe, 9001c: earphone portion, 9001: headset-type device, 9002a: housing, 9002b: secondary battery, 9002: device, 9003a: housing, 9003b: secondary battery, 9003: device, 9005a: display portion, 9005b: belt portion, 9005: watch-type device, 9006a: belt portion, 9006b: wireless power feeding and receiving portion, 9006: belt-type device, 9300: cleaning robot, 9301: housing, 9302: display portion, 9303: camera, 9304: brush, 9305: operation button, 9306: secondary battery, 9310: dust, 9400: robot, 9401: illuminance sensor, 9402: microphone, 9403: upper camera, 9404: speaker, 9405: display portion, 9406: lower camera, 9407: obstacle sensor, 9408: moving mechanism, 9409: secondary battery, 9500: flying object, 9501: propeller, 9502: camera, 9503: secondary battery, 9504: electronic component

What is claimed is:

1. A method for manufacturing a separator, comprising:
a first step of mixing a ceramic-based material comprising a metal oxide microparticle and a first solvent to form a first mixture;
a second step of mixing the first mixture, a first binder, and a second solvent to form a second mixture;
a third step of mixing the second mixture, a second binder, and a third solvent to form a third mixture;
a fourth step of applying the third mixture onto a polymer porous film; and
a fifth step of heating the polymer porous film coated with the third mixture at higher than or equal to 60° C. and lower than or equal to 300° C. to be dried.

2. The method for manufacturing the separator according to claim 1,
wherein the polymer porous film coated with the third mixture is heated at higher than or equal to 60° C. and lower than or equal to 200° C. to be dried in the fifth step.
